(19) United States
(12) Patent Application Publication
(10) Pub. No.: US 2026/0154063 A1
(43) Pub. Date: Jun. 4, 2026

(54) PRODUCT UPDATE DISTRIBUTION OPTIMIZATION

(71) Applicant: Ivanti, Inc., South Jordan, UT (US)

(72) Inventors: Aman Teja, San Jose, CA (US); Matthew M. Hazzard, Lino Lakes, MN (US); Josh Howard, Clarksburg, MD (US); Christopher J. Goettl, Owatonna, MN (US)

(73) Assignee: Ivanti, Inc., South Jordan, UT (US)

(21) Appl. No.: 19/404,990

(22) Filed: Dec. 1, 2025

Related U.S. Application Data
(60) Provisional application No. 63/726,507, filed on Nov. 30, 2024.

(51) Int. Cl. G06F 8/65

(52) U.S. Cl. CPC G06F 8/65

(57) ABSTRACT

A method of reducing operational impact resulting from a dysfunctional rollout of a product update in a managed network. The method includes initiating a distribution of a product update to a subset of endpoints according to a first distribution procedure. During the distribution, the method includes receiving input data related to the distribution; determining, based on the received input data, an optimized update distribution procedure for the product update and the managed network; and determining whether the optimized update distribution procedure includes an adjustment. Responsive to the optimized update distribution including an adjustment to a parameter of the first distribution procedure, the method includes modifying the parameter of the first distribution procedure according to the adjustment of the optimized update distribution to generate a modified distribution procedure. The method includes distributing the product update according to the modified distribution procedure to a second subset of endpoints of the managed network.

### CROSS REFERENCE TO RELATED APPLICATIONS

This application claims priority to and the benefit of U.S. provisional application no. 63/726,507, filed Nov. 30, 2024, which is incorporated herein by reference in its entirety. This application incorporates by reference co-pending U.S. applications Ser. No. 19/402,830, filed Nov. 26, 2025 and Ser. No. 19/402,824, filed Nov. 26, 2025.

### FIELD

The embodiments described in this disclosure are related to management of endpoints in managed networks, and more particularly to systems and methods of product update distribution optimization.

### BACKGROUND

In managed networks, update management services are implemented to ensure product updates and software patches are distributed to endpoints. The product updates may include new versions of the products or patches that address vulnerabilities or improve functionality of the products. The update management services can be automated using a distribution procedure. Conventional distribution procedures include static attributes. For instance, the static attributes might include distribution schedule, ring configurations, and the like. The static attributes may remain constant from one product update to another. The static attributes simplify deployment of the product updates to the administrator. However, the static attributes may slow deployment of the product updates. For instance, some of the product updates may be distributed more quickly than deployment according to static attributes. Conversely, distribution according to the static attributes may introduce risks to a managed network. For instance, the static attributes might move the product update at a rate that prevents proper evaluation of the product update. Accordingly, the product update may introduce a technical issue in the managed network.

Accordingly, there is a need in the field of network security and product update management to optimize product update distribution based on a balance between a speed of deployment and a risk introduced to the managed network by the product update.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a method of reducing operational impact resulting from a dysfunctional rollout of a product update in a managed network. The method may include initiating a distribution of a product update to a first subset of endpoints of the managed network according to a first distribution procedure. During at least a portion of the distribution of the product update to the first subset of endpoints according to the first distribution procedure, the method may include receiving input data related to the distribution of the product update directed to the first subset of endpoints of the managed network; determining, based on the received input data, an optimized update distribution procedure for the product update and the managed network; and determining whether the optimized update distribution procedure includes an adjustment. Responsive to the optimized update distribution including an adjustment to a parameter of the first distribution procedure, the method may include modifying the parameter of the first distribution procedure according to the adjustment of the optimized update distribution to generate a modified distribution procedure; and distributing the product update according to the modified distribution procedure to a second subset of endpoints of the managed network.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments described in the present disclosure may be implemented;

FIGS. 2A-2E depict an example process of reducing operational impact resulting from a dysfunctional product update rollout of a product update in a managed network that may be implemented in the operating environment of FIG. 1;

FIG. 3 is a sequence diagram of the process of FIGS. 2A-2E;

FIGS. 4A and 4B are a flow chart of an example method of reducing operational impact resulting from a dysfunctional rollout of a product update in a managed network;

FIG. 5 is a flow chart of another example method of reducing operational impact resulting from a dysfunctional rollout of a product update in a managed network;

FIG. 6 is a flow chart of another example method of reducing operational impact resulting from a dysfunctional rollout of a product update in a managed network; and

FIG. 7 illustrates an example computer system configured for reducing operational impact resulting from a dysfunctional rollout of a product update in a managed network,

all according to at least one embodiment described in the present disclosure.

### DESCRIPTION OF SOME EXAMPLE EMBODIMENTS

The embodiments described in this disclosure are related to systems and methods of product update distribution optimization. For instance, some embodiments leverage an artificial intelligence engine that is trained to optimize a balance between distribution speed and a risk of interruption introduced by a product update. The optimization engine is trained to increase a speed of a distribution procedure and reduce or eliminate a risk of interruptions to a managed network in which the product update is distributed. The optimization engine is fed input data that is related to one or more specific product updates, historical patch data, and the like. The optimization engine generates an output that indicates optimized attributes of a distribution procedure and endpoint configurations that enable rapid, customized, and adaptive distribution of product updates. The output from the optimization engine is received throughout the distribution of the product update to tune and to refine the distribution procedure. Additionally, the output from the optimization engine is received following the distribution to determine whether the product update failed after it is distributed.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures is not intended to limit the scope of the systems and methods, as claimed, but is merely representative of example configurations of the systems and methods.

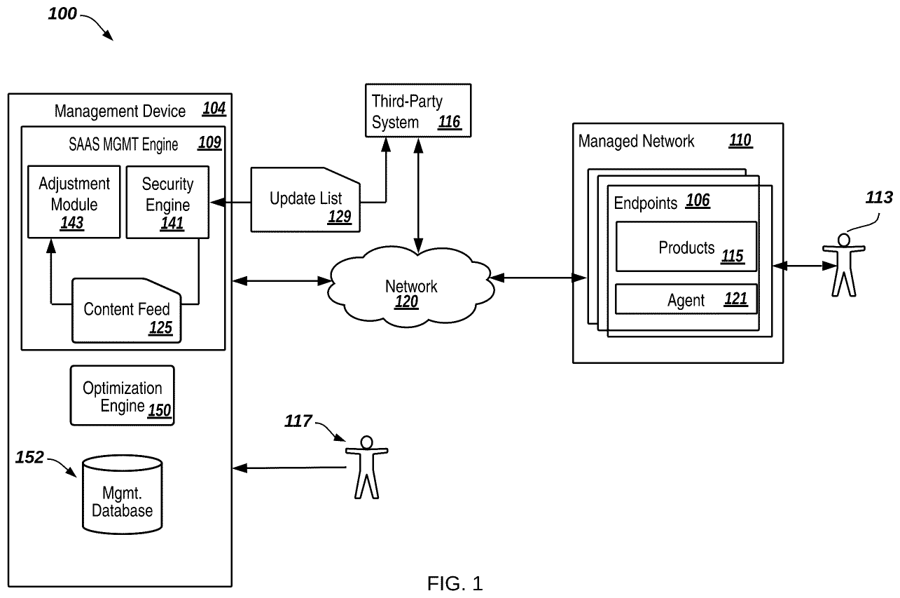

FIG. 1 is a block diagram of an example operating environment 100 in which some examples of the present disclosure can be implemented. The operating environment 100 may be configured for implementation of product update management in a managed network 110. The product update management may enable product updates such as patches and code changes to be accessed, consumed, and distributed to endpoints 106 of the managed network 110. In the operating environment 100, an adjustment module 143 may be implemented along with a security management optimization engine 150 (hereinafter, “optimization engine 150”) to optimize distribution of the product updates, to tune or adjust distribution procedures, identify whether the product update has failed or is failing following rollout of the product updates, and provide endpoint configurations and settings to mitigate or avoid a failed product update.

The embodiments of the present disclosure address multiple technical problems of conventional systems. For example, a common distribution procedure is a ring-deployment procedure in which the product update is distributed to groups or rings of endpoints sequentially. The rings increase in size as the distribution proceeds, which enables prioritization and testing of the product update as it is distributed. Conventional distribution procedures include static attributes. For instance, the static attributes might include a soak time, endpoint inclusion or election, ring configurations, etc. The static attributes may remain constant from one product update to another. There are some technical disadvantages to these conventional distribution procedures. For instance, the timing of the distribution may be poorly related to a particular product update. For instance, the product update may be simple and not affect many components of the endpoints. Accordingly, the static distribution procedure may be slower than necessary, which may result in vulnerabilities persisting on the endpoints or endpoints operating on outdated software. Alternatively, the product update may be complex and untested. As a result, the static distribution procedure may introduce unnecessary risk of product update failure by distributing the product update throughout a network without sufficient time to evaluate it.

Embodiments of the present disclosure address these and other technical limitations through use of the optimization engine 150 that is trained to optimize a balance between distribution speed and a risk of interruption introduced by the product update. The distribution speed includes a period of time required for the product update to be locally implemented by the endpoints 106. Multiple factors affect the distribution speed such as soak time, time between rings, and the like. The risk of interruption includes a failure of the endpoints 106 to install the product update, a technical issue or device anomaly that results from installation of the product update, a system or application failure, etc.

In particular, the optimization engine 150 is trained to increase a speed of a distribution procedure and reduce or eliminate a risk of interruptions to the managed network 110. The optimization engine 150 is fed input data that is related to one or more specific product updates, historical patch data, data from the managed network 110, and data from a management device 104. The optimization engine 150 generates output from the input data, which is the basis of distribution procedures and modifications to the endpoints 106 that enable rapid, customized, and adaptive distribution of product updates. The adjustment module 143 and the optimization engine 150 may be implemented prior to the distribution, during the distribution, and following the distribution. Accordingly, failures or potential failures may be identified and remedied throughout a product update rollout and after the product update is distributed to the endpoints. In some embodiments, the optimization engine 150 may include an artificial intelligence (AI) engine or may machine learning (ML) engine.

In the present disclosure, the management device 104 includes a single optimization engine 150. In some embodiments, the optimization engine 150 or some portion thereof may be remotely hosted. In these embodiments, the optimization engine 150 or a remote portion thereof may be accessed via the network 120. Accordingly, the input data may be communicated to the optimization engine 150 via the network 120 and output may be received from the optimization engine 150 via the network 120.

Additionally, in some embodiments, the management device 104 might include multiple optimization engines 150 of different types and optimization parameters. In these and other embodiments, multiple optimization engines 150 may be used in the operating environment 100 for different functions. For instance, a first optimization engine may be used for analysis prior to distribution, a second optimization engine may be used for analysis and tuning during distribution of a product update, and a third optimization engine may be used after distribution of the product update. As another example, the first optimization engine may be used for analysis prior to the distribution, and a second optimization engine may be used for analysis during and after distribution of the product update.

Additionally still, in embodiments in which two or more optimization engines are used, the two or more optimization engines may be trained based on different training data and may be trained towards different optimization objectives. For instance, a first optimization may be trained on data representative of operation of the endpoints and is trained to identify a disruption risk introduced by the product update and data indicative of the disruption risk occurring in the managed network. A second optimization engine may be trained using data representative of operation of the endpoints and is trained to find and learn a model for an optimal balance between a distribution speed of the product update and a disruption risk introduced by the product update to an enterprise.

The embodiments of the present disclosure are directed to a computer-centric problem and are implemented in a computer-centric environment. For instance, the examples of the present disclosure are directed systems and methods configured to define and implement product update distribution procedures that access, analyze, and execute update package generation and distribution in the managed network 110. Computing processes occurring in the operating environment 100 include communication and implementation of product updates that include software patches and code changes on products 115 loaded on the endpoints 106. Communications during the processes described in this present disclosure involve the communication of data in electronic and optical forms via a network 120 and involve the electrical and optical interpretation of the data and information.

The operating environment 100 may include the management device 104, the managed network 110, and a third-party system 116. The managed network 110 includes the endpoints 106. The components of the operating environment 100 are configured to communicate data and information via the network 120 to perform AI-based product update distribution management as described in the present disclosure. Each of these components are described in the following paragraphs.

The network 120 may include any communication network configured for communication of signals between the components (e.g., 104, 116, 110 and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The third-party system 116 includes a hardware-based computer device or collection thereof that is configured to communicate with the other components of the operating environment 100 via the network 120. The third-party system 116 is configured to provide access to one or more update lists 129, portions thereof, and information pertaining to entries of the update lists 129. For instance, the third-party system 116 may host a website on which the update lists 129 are available. The third-party system 116 may host or store the update lists 129 such that information, metadata, and data related to entries on the update lists 129 may be accessed via the network 120. For instance, the management device 104 may be configured to access the update lists 129 or information related to entries on the update lists 129 via the network 120. In some examples, the management device 104 may be configured to communicate an electronic message to the third-party system 116 that accesses the update lists 129, information (e.g., update metadata) related to entries on the update lists 129, or a specific portion of the update lists 129. Some examples of example APIs for accessing the update lists 129 are available at https://www.circl.lu/services/cve-search/.

The update lists 129 may include a list of entries. The entries relate to a cybersecurity threat, a cybersecurity vulnerability, a software application code change, a patch, a hardware interface modification, or another update to a product (e.g., the products 115). The entries have information related to them. For instance, one or more of the entries may include an identification number, an entry date, an entry summary, a link to product updates (e.g., a code change or patch), a threat severity, vulnerability risk, vendor severity rating, other metadata, or some combination thereof.

An example of the third-party system 116 may be Department of Homeland Security (DHS) server(s). In this example, the update lists 129 may include lists of common vulnerabilities and exposures (CVEs) hosted by the DHS servers. Another example of the third-party system 116 may be National Institute of Standards and Technology (NIST) servers. In this example, the update lists 129 may include a national vulnerability database that is hosted by the NIST servers. The NIST server may host the information assurance vulnerability alerts (IAVAs), which may be an example of the update lists 129. One with skill in the art may be familiar with other suitable examples of the third-party system 116 and the update lists 129. Lists of vulnerabilities and threats are maintained by some additional entities such as MITRE.

In some embodiments, the update lists 129 may be consumed at the management device 104 to generate a content feed 125, which is sometimes referred to as an update or patch catalog. The content feed 125 may be an aggregation of product updates included in the update lists 129. In addition to the aggregation of the updates, the content feed 125 may include update files as well as detection and deployment logic used to patch the products 115. The content feed 125 may be used in the security engine 141. For instance, the content feed 125 may populate a user interface that provides visibility to outstanding updates for the products 115 as well as the characteristics and parameters of the outstanding updates. The content feed 125 may also include an enumeration of outstanding product updates and update metadata associated with one or more of the outstanding product updates.

The content feed 125 may include records and information related to previous product updates (e.g., a code change or patch) as well as outstanding product updates. As the update lists 129 become available, updated metadata or other information may be appended to the content feed 125. The content feed 125 may be stored at least temporarily at the management device 104 or a management database 152. In other instances, the content feed 125 may be stored remotely and accessed by the management device 104 via the network 120.

In some examples, the operating environment 100 may include a support device that consumes the update lists 129 and generates the content feed 125. In these examples, the management device 104 might receive the content feed 125 from the support device.

The content feed 125 populates an update management service. Based on the content feed 125, outstanding updates may be identified and distributed to the endpoints. However, there are instances and circumstances in which the automated management service fails to address. For instance, in some circumstances, a zero-day vulnerability may be detected. A zero-day vulnerability may include a vulnerability in a product that is disclosed, but not yet patched. Zero-day vulnerabilities are particularly susceptible to exploitation by malicious actors. Accordingly, the speed at which the zero-day vulnerability is patched may be critical. In these conventional systems, there is no automated update process to identify the zero-day vulnerability and to distribute a patch (after it is developed). Accordingly, an administrator may have to manually deploy the patch, which causes additional delays. Moreover, some jurisdictions require the patch to be distributed within a predefined time, which causes an emergency or an urgent situation. As another example, in some managed networks, a first subset of products is updated frequently or more frequently than others. For instance, most products may be updated monthly, while others are updated weekly or every ten days. Accordingly, a single automated update process cannot efficiently update the products in these managed networks with different update frequencies. In these circumstances, either the update management operations are conducted more often than necessary to address the highest update frequency, or some updates (i.e., those directed to the more frequently updated products) are delayed, which may result in vulnerabilities or malfunctioning systems to persist.

The managed network 110 includes the endpoints 106. To implement the managed network 110, the endpoints 106 may be enrolled. After the endpoints 106 are enrolled, ongoing management of the endpoints 106 may be implemented by the management device 104. The ongoing management may include overseeing and dictating at least a part of the operations at the endpoints 106 as well as dictating or controlling product updates (e.g., a code change or a patch) implemented at the endpoints 106 as described in the present disclosure. The managed network 110 may be associated with an enterprise, a portion of an enterprise, a government entity, or another entity or set of devices.

The endpoints 106 may include hardware-based computer systems that are configured to communicate with the other components of the operating environment 100 via the network 120. The endpoints 106 may include any computer device that may be managed by the management device 104 and/or have been enrolled in the managed network 110. The endpoints 106 include devices that are operated by the personnel and systems of an enterprise or store data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines. The endpoints 106 may be referred to as managed endpoints when the endpoints 106 are included in the managed network 110.

The endpoints 106 may be associated with the users 113. The phrase “associated with” when describing the relationship between the endpoints 106 and the users 113 indicates that the users 113 generally or regularly operate the endpoints 106. The users 113 may be assigned a role or may be grouped with one or more other users 113.

The endpoints 106 include the products 115 and an agent 121. The agents 121 may be locally installed, at least temporarily, at the endpoints 106. For instance, the agents 121 may be installed at the endpoints 106 when the endpoints 106 are enrolled in the managed network 110 or when a particular service is loaded at the endpoints 106. The agents 121 may have access to information related to the products 115 and may be configured to communicate the information such as product metadata related to the products 115 to the management device 104. For instance, the agent 121 may have access to information related to the products 115. On its own or responsive to a request (from the management device 104 or another endpoint 106), the agent 121 may communicate the information related to the products 115 to the management device 104. The information related to the products 115 may include a current inventory of the products 115 as well as information or product metadata related to the products 115 such as version, vendor, type, hardware integrations, size, privacy policy, software interfaces, and the like. The agents 121 may also implement administrative and/or management processes within the managed network 110.

The products 115 may include applications of any kind or type. Some examples of the products 115 may include software applications, enterprise software, operating systems, and the like. The products 115 may differ between the endpoints 106. The products 115 may be individually patched or updated in some embodiments or circumstances. Additionally, two or more of the products 115 may have outstanding product updates at the same time (e.g., at the end of the month). Distribution of the two or more products 115 may be analyzed together. For instance, input data related to the two or more products 115 may be provided to the optimization engine 150. Accordingly, the adjustment module 143 may generate a distribution procedure and/or a parameter modification that are applicable to the two or more products 115.

In the managed network 110 of FIG. 1, the endpoints 106 may be located in different jurisdictions or geographic locations. For instance, a first subset of the endpoints 106 may be located in a first jurisdiction and a second subset of the endpoints 106 may be located in a second jurisdiction. Accordingly, the first subset may be subject to different policies than the second subset.

The management device 104 is configured to manage product updates (e.g., a code change or patch) at the endpoints 106. In general, management of the product updates may include determining which product updates pertain to the products 115, determining which of the product updates to distribute to the endpoints 106, and to distribute the product updates to the endpoints 106 such that the product updates may be locally implemented. Implementation of the product updates at the endpoints 106 include modification to computer code, programming code, or computer-executable instructions of a program that may include the products 115. In addition, in the operating environment 100, the management device 104 may be configured to leverage the optimization engine 150 to optimize one or more operations related to product update management as described elsewhere in the present disclosure.

The management device 104 may include a hardware-based computer system that is configured to communicate with the other components of the operating environment 100 via the network 120. In some examples, the management device 104 may be a single server, a set of servers, a virtual device, or a virtual server in a cloud-base network of servers. In these and other examples, the security engine 141, the adjustment module 143, and the optimization engine 150 may be spread over two or more cores, which may be virtualized across multiple physical machines.

The management device 104 may be associated with an administrator 117. The administrator 117 may be an individual, a set of individuals, or a system that interfaces with the management device 104. In some examples, the administrator 117 may provide input such as admin input to the management device 104. The input provided by the administrator 117 may form data and information used as input data to the optimization engine 150. Input provided by the administrator 117 may also form the basis of some computing processes performed by the management device 104. The user input may take the form of a selection of an icon or button on the management device 104 in some embodiments.

The management device 104 may provide one or more additional management operations to the endpoints 106 (e.g., in addition to product update managed). To provide the management operations, the management devices 104 includes a SAAS management engine (in the Figures “SAAS MGMT engine”) 109 that is configured to perform the one or more management operations relative to the endpoints 106. For instance, the SAAS management engine 109 may ensure the endpoints 106 are up to date, may ensure users 113 of the endpoints 106 have access to products 115 suitable for a role or function, the SAAS management engine 109 may provide technical support to the endpoints 106, and the like. In some embodiments, one or more modules of the SAAS management engine 109 may implement parameter modifications at the endpoints 106. For instance, the parameter modification may include disabling one of the products 115 at one of the endpoints 106. An application control module included in the SAAS management engine 109 may communicate a command that disables the product 115 at the endpoints 106.

The security engine 141 may be included in the SAAS management engines 109. The security engine 141 may be configured for automated software management of the endpoints 106 of the managed network 110. In the operating environment 100, the security engine 141 may be configured to implement distribution procedures for product updates. For instance, the adjustment module 143 may generate one or more distribution procedures (e.g., a first distribution procedure and one or more modified distribution procedures). The security engine 141 may then distribute one or more applicable product updates according to the distribution procedures.

The management device 104 may include the optimization engine 150 and a management database 152. The optimization engine 150 may include a security management AI engine. In these and other embodiments, the optimization engine 150 is trained on data representative of the operation of the endpoints 106 and is trained to find and learn a model for an optimal balance between a distribution speed of product updates and a disruption risk introduced by the product updates to an enterprise that is associated with the managed network 110. The optimization engine 150 may include a generative AI that is trained on at least some historical data representative of product updates, product update failure, product update metadata, characteristics of the endpoints 106, etc. that indicate sources of product update failures and relationships between product update failures and characteristics of endpoints, product updates, etc. The optimization engine 150 may include one or more machine learning algorithms implemented to understand the relationship between product update failures and underlying causes thereof.

The management database 152 may include non-tangible, computer readable memory (e.g., the memory 312 of FIG. 3). The management database 152 may be configured to store historical product update data related to the managed network 110 and/or other networks. In addition, the management database 152 may store the content feed 125, lists of data related to the endpoints 106, the managed network 110, data related to outstanding product updates, and the like. The adjustment module 143 may access data and information stored at the management database 152.

The security engine 141, the adjustment module 143, and the optimization engine 150 may interface to optimize product update distribution in the management device 104. Optimization of the product update distribution may reduce operational impact that may result from a dysfunctional product update rollout in the managed network 110. The adjustment module 143 may be configured to receive input data related to distribution of a product update directed to one or more of the endpoints 106 of the managed network 110. The input data may include data representative of parameters of one or more of the endpoints 106, historical deployment failure data that may be stored at the management database 152, device state of one or more of the endpoints 106, metadata of the product update that may be accessed from the third-party system 116, application telemetry of one or more of the products 115, patch history statistics of one or more of the endpoints 106 and/or one or more of the updates, user feedback and sentiment of the user 113, the content feed 125 received from the security engine 141, the update lists 129 received from the third-party system 116, rates or numbers of deployment failures, and failure in particular endpoints 106 characterized by device type, or products implemented on particular endpoints, other input data or combinations thereof.

The adjustment module 143 may submit the input data to the optimization engine 150. The optimization engine 150 may generate an output representative of one or both of an optimized update distribution procedure and an endpoint configuration that enables distribution of the product update. The optimization engine 150 may communicate the output to the adjustment module 143.

The adjustment module 143 or a component thereof may generate a distribution procedure that conforms to the optimized update distribution procedure of the output. The distribution procedure may be communicated to the security engine 141. The security engine 141 may distribute the product update to the endpoints according to the distribution procedure.

Additionally, the adjustment module 143 may also generate a parameter modification that is configured to modify a parameter or a state of one or more of the endpoints to conform the endpoint to a particular endpoint configuration of the output. The parameter modification may be implemented at one or more of the endpoints to change a parameter or a state thereon.

In some embodiments, the adjustment module 143 may access additional input data during the distribution of the product update and following the distribution of the product update. The additional input data may be communicated to the optimization engine 150. The additional input data may provide information about a product update rollout as it occurs and whether the product update failed after it is distributed. The optimization engine 150 may generate additional output that is communicated to the adjustment module 143. The adjustment module 143 may generate modified distribution procedures and/or feature modifications. The modified distribution procedures may be communicated to the security engine 141 where it may be implemented during a rollout of the product update or during a redistribution of the product update. The feature modifications may be implemented at the endpoints 106 during or after the rollout of the product update.

The agent 121, the optimization engine 150, the security engine 141, the adjustment module 143, the products 115, and components thereof may be implemented using hardware including a processor, a microprocessor (e.g., to perform or control performance of one or more operations), a field-programmable gate array (FPGA), or an application-specific integrated circuit (ASIC). In some other instances, the agent 121, the optimization engine 150, the security engine 141, the adjustment module 143, the products 115 and components thereof may be implemented using a combination of hardware and software. Implementation in software may include rapid activation and deactivation of one or more transistors or transistor elements such as may be included in hardware of a computing system (e.g., the endpoints 106 or the management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more management devices 104, one or more endpoints 106, one or more third-party systems 116, or any combination thereof. Moreover, the separation of various components and devices in the examples described herein is not meant to indicate that the separation occurs in all examples. Moreover, it may be understood with the benefit of this disclosure that the described components and servers may generally be integrated together into a single component or server or separated into multiple components or servers.

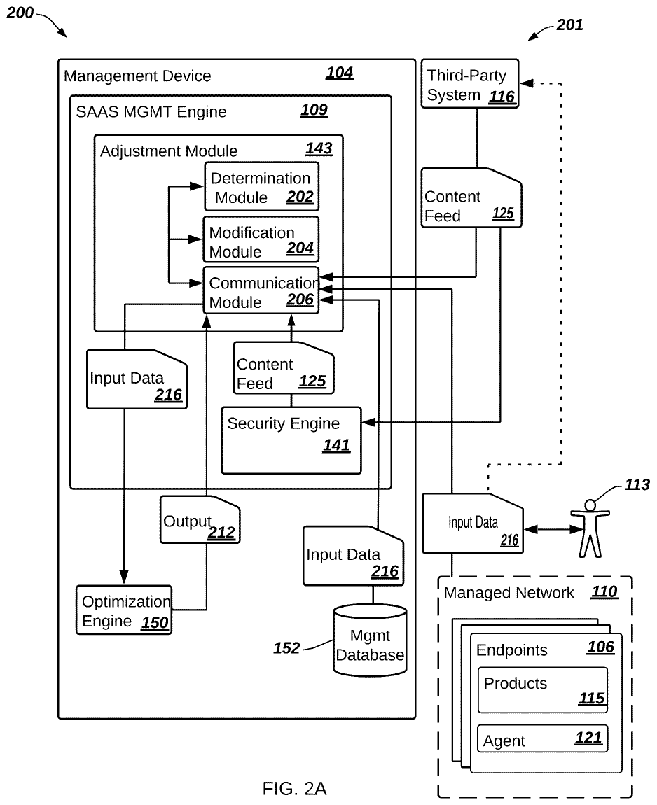

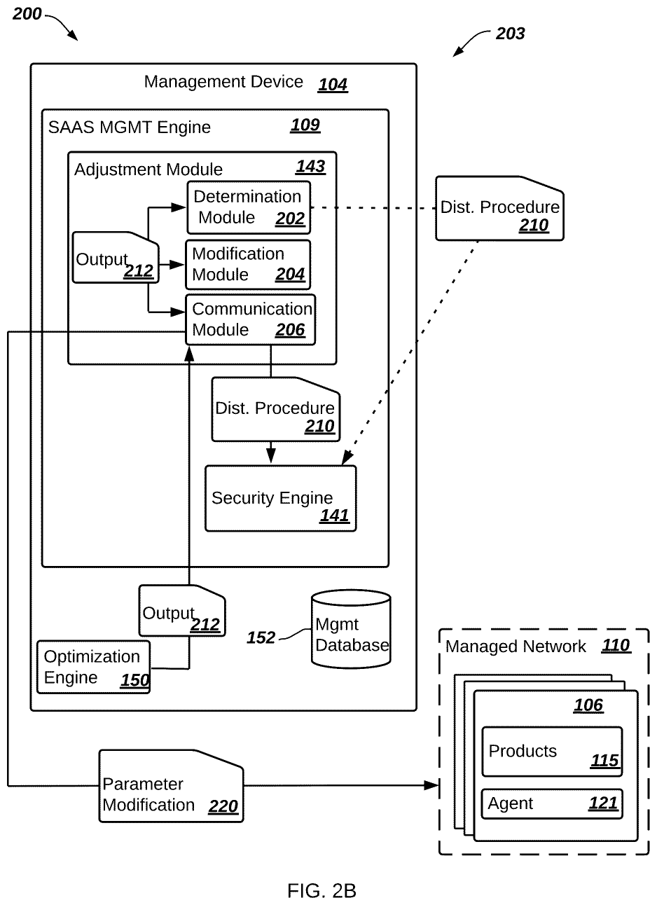

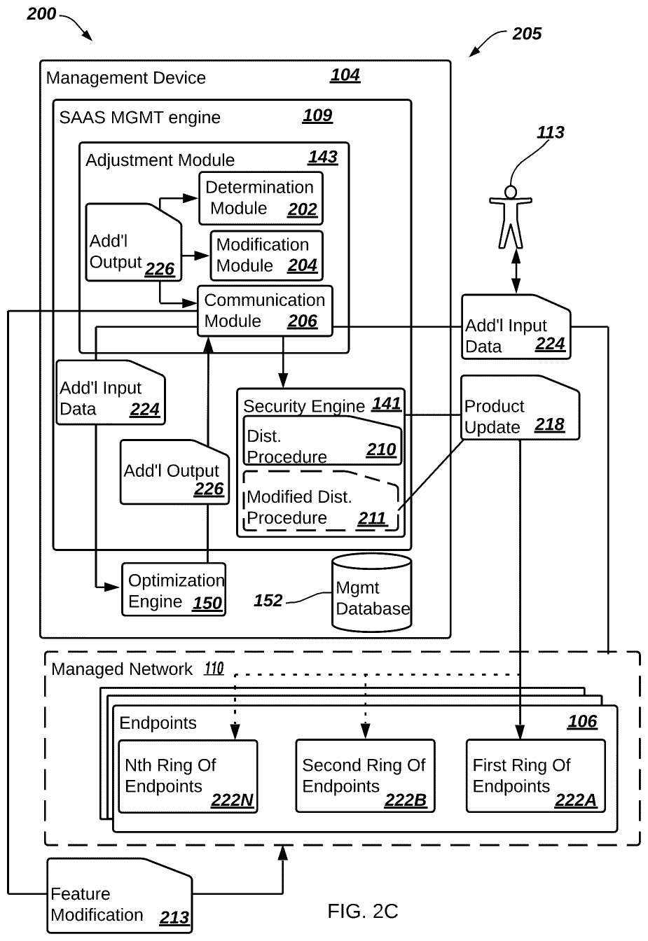

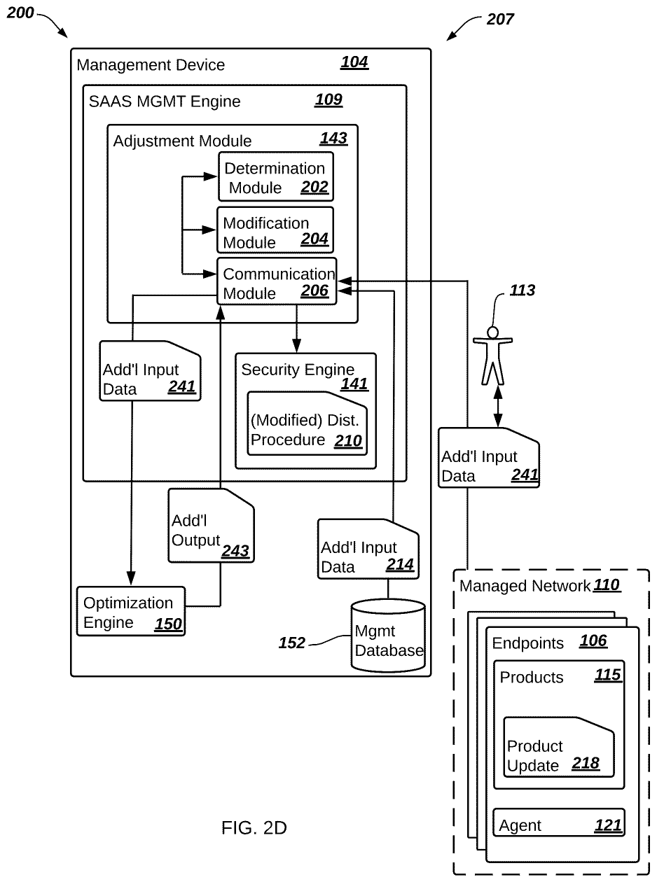

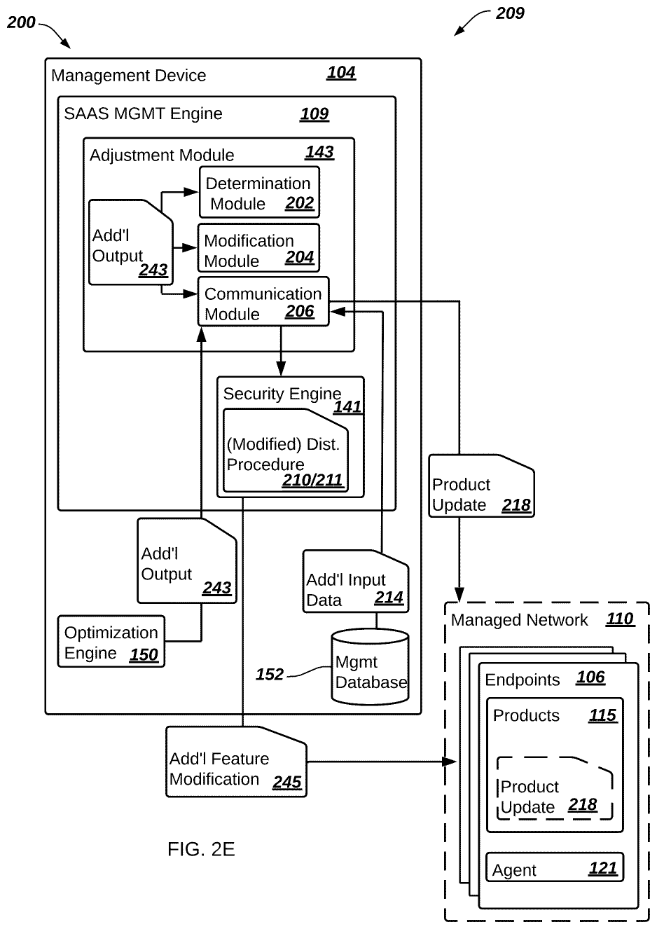

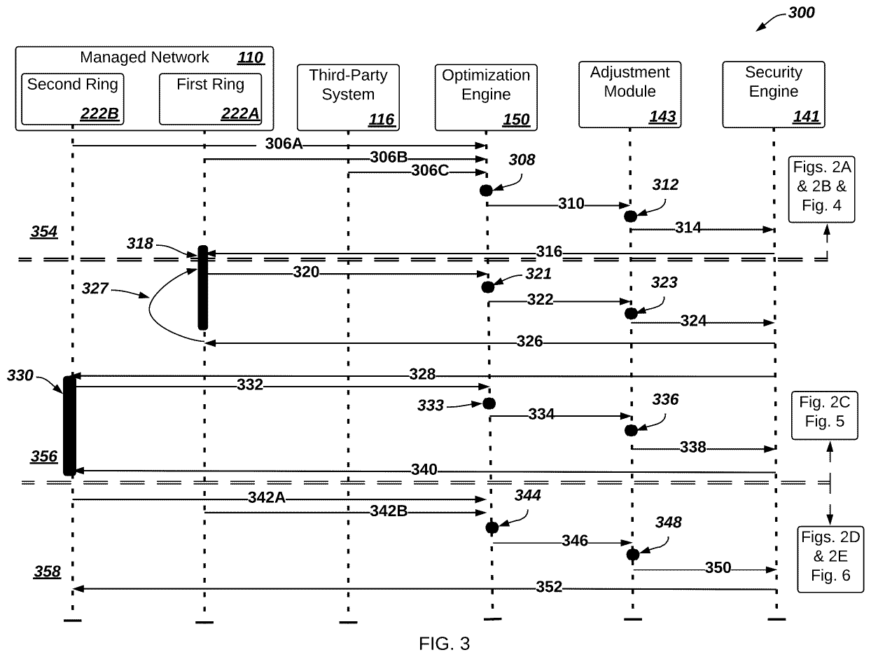

FIGS. 2A-2E depict an example process 200 of reducing operational impact resulting from a dysfunctional rollout of a product update in the managed network 110. The process 200 may be implemented in the operating environment 100 of FIG. 1 or another suitable environment. FIGS. 2A-2E include some of the components (104, 109, 143, 141, 110, 106, etc.) described with reference to FIG. 1. Although not depicted in FIGS. 2A-2E, communication of data and information may be via a communication network such as the network 120 of FIG. 1.

In FIGS. 2A-2E, the adjustment module 143 includes a communication module 206, a determination module 202, and a modification module 204. The communication module 206 is configured to access and receive data and information as well as communicate data and information to the security engine 141, the optimization engine 150, etc. The determination module 202 and the modification module 204 are configured to generate distribution procedures, and endpoint configuration instructions based on output from the optimization engine 150. The determination module 202 and the modification module 204 may further generate and distribution adjustments and modifications to the distribution procedures and endpoint configurations based on additional output. Accordingly, as detailed in FIGS. 2A-2E, the adjustment module 143 actively collects input data (e.g., 216) from the managed network 110 and leverages the optimization engine 150 to obtain insights to optimize product update distribution.

FIGS. 2A-2E depict operations that may be included in the process 200. For instance, FIGS. 2A and 2B depict operations that may be included prior to distribution of a product update 218. The operations of FIGS. 2A and 2B may result in a predictive output from the optimization engine 150, which may optimize the rollout or distribution of the product update 218 prior to initiation of a distribution operation of the product update 218. FIG. 2C is directed to operations that may occur during the distribution operation. In some implementations, the operations of FIG. 2C may be performed following the operations of FIGS. 2A and 2B. In some implementations, FIGS. 2A and 2B may not occur and the operations of FIG. 2C may be implemented independently or prior to the operations of FIGS. 2D and 2E. Moreover, the operations of FIG. 2C may be repeated multiple times during distribution of the product update 218. The operations of FIGS. 2D and 2E may be implemented following distribution of the product update 218. For instance, the operations of FIGS. 2D and 2E may be implemented after the operations of FIGS. 2A and 2B, after the operations of FIGS. 2A-2C, or after the operation of FIG. 2C. Additionally, the operations of FIGS. 2D and 2E may be implemented two or more times.

FIG. 2A is a block diagram of an example input data collection 201 operation of the process 200. In FIG. 2A, input data 216 may be received by a communication module 206 of the adjustment module 143. The input data 216 is related to distribution of one or more product updates directed to or outstanding at the endpoints 106 of the managed network 110.

The input data 216 may be received from one or more input sources (e.g., 113, 110, 106, and 152). The input sources may provide or enable access to one or more portions of the input data 216. For example, a first input source may include the user 113. The user 113 may generate or provide user feedback and sentiment, which may be included in the input data 216. The user feedback and the sentiment may include opinions and comments regarding operation of one of the endpoints 106, a patch update, the managed network 110, other feedback, or some combination thereof. In some circumstances, the input data 216 derived from the user 113 may be provided via one of the endpoints 106. For instance, the user 113 may provide user feedback directly to one of the endpoints 106 of the managed network 110. Additionally or alternatively, the input data 216 derived from the user 113 may be entered into a public site (e.g., a social media site, a product update or application evaluation site, and the like) or the third-party system 116. The communication module 206 may access the input data 216 from the third-party system 116 or the public site. In some embodiments, information related to the user 113 may be included in the input data 216. For instance, a role of the user 113, geography or location of the user 113, a security attribute, an assigned endpoint 106. etc. may be included in the input data 216 that is derived from the user 113.

A second input source may include the third-party system 116. As introduced with reference to FIG. 1, the third-party system 116 may communicate the update lists (e.g., update lists 129 of FIG. 1), the content feed 125, or some basis therefore to the security engine 141. The content feed 125 includes one or more product updates outstanding at the endpoints 106 or potentially outstanding at the endpoints 106. Additionally, the content feed 125 may include update metadata that is related to the product updates. The update metadata may include an update criticality, which of the products 115 an update applies to, a version, a release date, installation information, etc. The content feed 125 may be accessed by the communication module 206 from the third-party system 116 and/or the security engine 141.

A third input source may provide data and information related to the endpoints 106 or the managed network 110. For example, parameters, characteristics, error log information (e.g., application error logs, device error logs, and the like), and operational configuration of one or more of the endpoints 106 may be communicated to the communication module 206. In some embodiments, the input data 216 may be communicated by the agent 121. Additionally, in some embodiments, the SAAS management engine 109 might include a discovery module or an application control module, which may discover, manage, and track the endpoints 106 and the products 115 at the endpoints 106. In these and other embodiments, at least a portion of the input data 216 associated with the endpoints 106 or the managed network 110 may be stored at the management database 152 and accessed by the communication module 206. Some examples of information related to the endpoints 106 that might be included in the input data 216 may include a device type, a list of the products 115, a device state of the endpoints 106, a geography of the endpoints 106, a network connection type of the endpoints 106, a data storage setting, a firewall setting, an enrolment status, and the like.

A fourth input source may include data and information related to the products 115. The data and information related to the products 115 may be communicated to the communication module 206. Similar to the information related to the endpoints 106, product information may be communicated by the agent 121 or management modules of the management device 104. At least a portion of this data may be stored at the management database 152 and accessed by the communication module 206. Some examples of information related to the products 115 that might be included in the input data 216 may include a version, patch history statistics, a data encryption policy, an identifier, a communication port, a product name, a product size, and the like. In addition, in some embodiments, the information related to the products 115 may include application telemetry of the products 115 installed on the endpoints 106. For instance, during operation of the products 115, telemetry data may be communicated to the management device 104 or the SAAS management engine 109. The telemetry data may indicate operation, location, license, user, etc. of the product 115.

A fifth input source may provide patch history statistical data. The patch history statistical data may be stored at the management database 152 at least temporarily and accessed by the communication module 206 as the input data 216. The patch history statistical data may include historical deployment failure data, which may be categorized by a characteristic of the endpoint 106 (e.g., device type, location, configuration, etc.) that experienced the failure. For instance, a first product update fails at Apple™ iPhones™ running version of iOS™ prior to 18.1. Additionally, the patch history statistical data may include rates or numbers of deployment failures in the managed network 110 and/or among portions of the endpoints 106.

The communication module 206 may receive the input data 216. The communication module 206 may then submit the input data 216 or some derivative or portion thereof to the optimization engine 150. The optimization engine 150 may communicate an output 212 to the communication module 206. The output 212 may be representative of one or both of an optimized update distribution procedure and an endpoint configuration that enables distribution of one or more product updates. For instance, the optimized update distribution procedure may optimize a balance between a distribution speed of the one or more product updates and a disruption risk introduced by the product updates to an enterprise associated with the managed network 110.

In some embodiments, the output 212 may include a predictive output. The predictive output may provide information used by the adjustment module 143 and the security engine 141 as a basis for an initial distribution or attempted distribution of the product updates to the managed network 110. For instance, in some conventional patch distribution systems, rollout of a product update may be implemented according to a static or a default ring-deployment procedure. In the static or default ring-deployment procedure, attributes of the procedure are maintained irrespective of the product update that is outstanding in an associated managed network. In the embodiment of FIG. 2A, the output 212 may be used by the determination module 202 and/or the modification module 204 to develop a product update-specific distribution procedure.

For example, the output 212 may include an indication that a scaled distribution of the one or more products updates to the endpoints 106 is likely to fail. Accordingly, the determination module 202 may generate configurations for the endpoints 106, which may enable successful distribution, or the determination module 202 may generate a first distribution procedure that may enable successful distribution. In some circumstances, the output 212 may indicate that product updates may fail, and the modification module 204 and the determination module 202 may be unable to generate endpoint configurations and distribution procedures that are likely to lead to successful distribution. In these and other circumstances, the modification module 204 and the determination module 202 may be configured to alert an administrator to cancel or re-evaluate distribution of the product update.

In another example, the output 212 may include an indication of an overall time anticipated for a successful installation of the product update. The overall time may be based on trends of the longest running patches for the endpoints 106 or the managed network 110. The overall time may enable an administrator to plan for a convenient time such as during a maintenance window, to perform the process 200.

In some embodiments, the overall time may be used to determine whether the product update can be successfully rolled out during a planned maintenance window. For instance, if the overall time extends beyond the planned maintenance window, then the security engine 141 may not begin distribution operations of the process 200. If, however, the overall time is within the planned maintenance window, then the security engine 141 may initiate distribution operations of the process 200. Additionally or alternatively, the output 212 may include a proposed maintenance window. For instance, the output 212 may include the overall time and may further include a calculated maintenance window based on the overall time. That is, the calculated maintenance window may be based on the overall time with a particular interval (e.g., 15 minutes, 30 minutes, an hour, or another particular interval) added to it.

Additionally, in some embodiments, the content feed 125 may indicate that multiple product updates are outstanding at the endpoints 106 or some portion thereof. In these and other embodiments, the output 212 may include identification of one or more problematic product updates. For instance, the output 212 may include an indication that one or more of the multiple product updates may fail, may cause instability, or may perform poorly after installation at a portion of the endpoints 106. Accordingly, the output 212 may identify the one or more problematic product updates. The output 212 may further include a recommendation not to install the problematic product update(s).

FIG. 2B provides some additional details of the use of the output 212 by the adjustment module 143 according to some embodiments of the present disclosure. FIG. 2B is a block diagram of an example distribution preparation operation 203, which may be a portion of the process 200. The distribution preparation operation 203 begins with receipt of the output 212 from the optimization engine 150 as described in FIG. 2A. The communication module 206 may then communicate the output 212 to the determination module 202 and the modification module 204.

The determination module 202 may be configured to generate a distribution procedure 210 based on the output 212. In particular, the determination module 202 may be configured to generate the distribution procedure 210 that conforms to an optimized update distribution procedure for the one or more product updates. For example, the output 212 may include one or more settings of a distribution procedure that is likely to lead to successful distribution of the product updates. The determination module 202 may have access to settings of a default distribution procedure and make modifications to the settings based on the output 212. For instance, the security engine 141 may implement a default or existing ring deployment procedure for the distribution of product updates. In the existing ring deployment procedure, the soak time may be twenty-four hours between rings. The output 212 may indicate that the twenty-four-hour soak time may be insufficient for distribution of a particular product update that is outstanding in the managed network 110. Accordingly, the determination module 202 may increase the twenty-four-hour soak time to thirty-two hours, or another suitable soak time. Similarly, the output 212 may suggest settings such as a sequence of product update distribution when multiple product updates are outstanding, ring targets (e.g., the endpoints 106 included in each ring), a number of rings, a number of the endpoints 106 or a percentage of the endpoints 106 in the rings, an overall time to successful deployment, a time to initiate subsequent rings, other ring definition attributes, other settings in distribution procedures, or combinations thereof.

In an example, the output 212 may indicate that a product update (e.g., a product update 218 described below) may be problematic at a first endpoint of the endpoints 106 and successful at a second endpoint of the endpoints 106. After receiving the output 212, the determination module 202 may determine that distribution of the product update to the first endpoint is likely to result in a failed rollout and that distribution of the product update to the second endpoint is likely to result in a successful rollout. Accordingly, the determination module 202 may assess whether the first and the second endpoints are included in rings of a default distribution procedure. In response to the first endpoint being included in a first ring (e.g., a smallest, first executed ring), the default distribution procedure may be modified to include the second endpoint instead of the first endpoint. The first endpoint may be moved to a later or the last ring, to improve speed of distribution through the first ring.

In addition, the output 212 may include a parameter of an update package used to install one or more of the product updates at the endpoints 106. For instance, the update package may include scripting that the modifies a state of the endpoint 106 prior to or following installation of the product update. The output 212 may include one or more scripts that may be included in the update package. Another example may include reboot-procedure suggestions, priority of a first product update relative to another product update, deployment in particular geography, etc. The determination module 202 may generate the update packages based on the output 212 or at least indicate to a package developer any changes to the update package that should be made to improve the likelihood of successful distribution.

The determination module 202 may communicate the distribution procedure 210 to the security engine 141. In the depicted embodiment, the communication of the distribution procedure 210 may be communicated via the communication module 206 or directly to the security engine 141. The modification module 204 may be configured to receive the output 212 from the communication module 206. The output 212 may include endpoint configuration information that enables optimized distribution of the product updates. For instance, the endpoint configuration information provides settings and parameters implemented on the endpoints 106 that enable optimized distribution of the product updates.

Based on the output 212, the modification module 204 may generate a parameter modification 220. The parameter modification 220 may include instructions, commands, and computing codes configured to modify or set one or more parameters at the endpoints 106 to conform one or more of the endpoints to an optimized endpoint configuration. In some embodiments, the parameter modification 220 may be communicated to the agent 121, which may implement the modifications.

In some embodiments multiple product updates may be outstanding at the endpoints 106. In these embodiments, the endpoint configuration included in the output 212 may include one or more endpoint sub-configurations. The endpoint sub-configurations may represent a set or series of changes to the endpoints 106 that may be implemented during distribution of the multiple product updates.

The modification module 204 may communicate the parameter modification 220 to the communication module 206 that may forward the parameter modification 220 to the endpoints 106. Alternatively, another module such as the security engine 141 or another module of the SAAS management engine 109 may communicate the parameter modification 220 to the endpoints 106.

In some embodiments, the parameter modification 220 may not be implemented. For instance, the distribution procedure 210 may be generated and the parameter modification 220 may not occur.

FIG. 2C is a block diagram of an example ongoing distribution analysis operation 205 of the process 200. The ongoing distribution analysis operation 205 may occur as a product update 218 is distributed to the endpoints 106 or at least during a portion of the distribution of the product update 218. For instance, the ongoing distribution analysis operation 205 may occur after the distribution procedure 210 is received at the security engine 141 and the parameter modification 220 may have been implemented at the endpoints 106 as described with reference to FIG. 2B.

In the embodiment of FIG. 2C, the product update 218 is distributed in a ring deployment operation, which is generally indicated by 219. Accordingly, in these and other embodiments, the first distribution procedure 210 may define rings 222A-222C of endpoints 106. For instance, a first ring 222A may include a first percentage (e.g., one percent) or a first number of the endpoints 106, a second ring 222B may include a second percentage (e.g., nine percent) or a second number of the endpoints 106, and a third ring 222C (e.g., ninety percent) or a third number of the endpoints 106. The product update 218 may first be distributed to target endpoints 106 included in the first ring 222A. There may be a period of time, referred to as a soak time, which allows some time for the endpoints 106 of the first ring 222A to install the product update 218. After a percentage or all of the endpoints 106 of the first ring 222A have installed the product update 218, the security engine 141 may distribute the product update 218 to the endpoints 106 of the second ring 222B. There is a second soak time, which provides some time for the endpoints 106 of the second ring 222B to install the product update 218, etc. The ring deployment operation 219 enables a sequential rollout of the product update 218. Failure at the first ring 222A may indicate that the product update 218 is not suitable for scaled distribution into the second and third rings 222B and 222C.

Using the first distribution procedure 210, the security engine 141 may begin distributing the patch update to the endpoints 106. During at least a portion of the distribution of the product update 218, additional input data 224 may be accessed or collected by the communication module 206. For instance, the additional input data 224 may be received from the endpoints 106 (e.g., the endpoints of the first ring 222A), the managed network 110, the user 113, and other input data sources. The additional input data 224 may be received during at least a portion of the distribution of the product update 218 according to the first distribution procedure. The additional input data 224 may include parameters of one or more of the endpoints 106, historical deployment failure data, device state of one or more of the endpoints 106, metadata of the product update 218, application telemetry of the products 115 installed on the endpoints 106, patch history statistics of one or more of the endpoints 106 and/or of a product update, user feedback and sentiment, failure in particular endpoints characterized by device type, products implemented on particular endpoints, other input data related to distribution of the product update 218, or some combination thereof.

The communication module 206 may submit the additional input data 224 to the optimization engine 150. In response, the optimization engine 150 may communicate additional output 226 to the communication module 206. The additional output 226 may include one or both of an adjustment to a parameter of the first distribution procedure 210 (e.g., a modification to an attribute of the ring deployment operation 219) and a feature of the endpoint configuration. The additional output 226 may be communicated to the determination module 202 and the modification module 204 from the communication module 206.

Based on the additional output 226, the determination module 202 and the modification module 204 may be configured to generate modifications to the first distribution procedure 210 to generate a modified distribution procedure 211 and/or feature modifications 213. The communication module 206 may communicate the modified distribution procedure 211 to the security engine 141 and communicate the feature modification 213. The feature modification 213 may include instructions (e.g., computing instructions) that change the state or a setting of one or more of the endpoints 106.

The modified distribution procedure 211 may include adjustments to one or more attributes of the first distribution procedure 210. Some examples of the adjustments may include automatically modifying a soak time for the product update, automatically modifying a ring target, automatically modifying ring target election, automatically modifying number of the endpoints in a ring or a percentage of the managed network in a ring, automatically modifying a time to successful deployment, automatically modifying a time to initiate a subsequent ring following successful deployment of an earlier ring, automatically modifying a ring definition, other parameters of the first distribution procedure 210, or some combination thereof.

For example, in some embodiments, the first distribution procedure 210 may include an attribute that requires feedback indicating that a particular portion of the endpoints 106 in the first ring 222A have successfully installed the product update 218 prior to advancing to the second ring 222B. The additional output 226 may indicate that a particular device type is experiencing high levels of failures relative to other device types. The adjustment may drop the particular device type from the feedback requirement and instead rely on feedback from the endpoints 106 of other device types. Accordingly, the ring deployment may advance to a subsequent ring after sufficient feedback is received from the endpoints 106 of the other device types.

Similarly, the first distribution procedure 210 may be implemented to distribute multiple product updates. The first distribution procedure 210 may include an attribute that requires feedback indicating that a particular portion of the endpoints 106 in the first ring 222A have successfully installed the multiple product updates prior to advancing to the second ring 222B. The additional output 226 may indicate that a particular product update of the multiple product updates is experiencing high levels of failures relative to other product updates of the multiple product updates. The adjustment may drop the particular product update from the feedback requirement and instead rely on feedback from the endpoints 106 related to the other product updates. Accordingly, the ring deployment may advance to a subsequent ring after sufficient feedback is received from the endpoints 106 related to the other product updates.

As another example, in some embodiments, the first distribution procedure 210 may be implemented to distribute the multiple product updates. The first distribution procedure 210 may include an attribute that requires feedback indicating that a particular portion of the endpoints 106 in the first ring 222A have successfully installed the multiple product updates prior to advancing to the second ring 222B. The additional output 226 may indicate that a particular product update of the multiple product updates is experiencing high levels of failures relative to other product updates of the multiple product updates. The adjustment may stop installation of the particular product update and instead continue to advance the other product updates through subsequent rings. The particular product update may be distributed independently through a sequence of the rings 222 independently.

The security engine 141 may then distribute the product update 218 using the modified distribution procedure 211 for at least a period of time. For instance, the product update 218 may distribute the product update 218 to the first ring 222A using the first distribution procedure 210. The modified distribution procedure 211 may be generated after distribution to the first ring 222A. The security engine 141 may then distribute the product update 218 according to the modified distribution procedure 211.

In some embodiments, the ongoing distribution analysis operation 205 may be a continual process during the distribution of the product update 218. In these and other embodiments, the receiving of the additional input data 224 may include a continual data gathering process that occurs during the distribution of the product update 218 according to the first distribution procedure 210 and one or more modified distribution procedures 211. Accordingly, in the embodiment of FIG. 2C, the modifying the attribute of the first distribution procedure 210 or the modified distribution procedure 211 may be a continual, adaptive process that tunes distribution procedures 210 and 211 as the product update 218 is distributed to the managed network 110.

FIG. 2D is a block diagram of an example a post-distribution analysis operation 207 of the process 200. The post-distribution analysis 207 may occur after the product update 218 is distributed to the endpoints 106 or a portion thereof. For instance, the product update 218 may have been successfully distributed to the endpoints 106 as described with reference to FIG. 2C. The post-distribution analysis 207 may be implemented to determine whether the product update 218 has failed or is failing. A failing product update or a failed update might include a persistent vulnerability (e.g., the vulnerability exists after the product update 218 is installed), a new malfunction after the distribution of the product update 218, an interoperability malfunction (e.g., between the products 115) after the distribution of the product update 218, or some combination thereof.

After the product update 218 is distributed, the communication module 206 may be configured to receive additional input data 241. In the post-distribution analysis operation 207, the additional input data 241 may include user feedback and sentiment information and/or device state data of one or more of the endpoints 106. In some embodiments, the device state data may be derived from error log information, which may be accessed from the endpoints 106 or from a module of the SAAS management engine 109.

As described elsewhere in the present disclosure, the user feedback and sentiment may be collected or accessed from the user 113 and the device state may be collected or accessed from the endpoints 106 or another module of the SAAS management engine 109. Other types of additional input data 241 may be used in the post-distribution analysis 207. In some embodiments, the user feedback and sentiment and device state of one or more particular endpoints 106 may be prioritized. For instance, the user feedback and sentiment and device state of the one or more particular endpoints 106 may indicate that the product update 218 is failing or has failed at these endpoints 106.

The communication module 206 may submit the additional input data 241 to the optimization engine 150. The optimization engine 150 may process the additional input data 241 and generate an additional output 243. The additional output 243 of FIG. 2D may include an indication that the distribution of the product update 218 failed or is failing, a modification to a parameter of the distribution procedure 210 or 211, an additional adjustment to a feature of the endpoint configuration, or some combination thereof. The additional output 243 may be communicated to the communication module 206 of the adjustment module 143.

FIG. 2E is a block diagram of an example redistribution operation 209 of the process 200. The redistribution operation 209 may begin following receipt of the additional output such as receipt of the additional output 243 of FIG. 2D. The additional output 243 may be received by the communication module 206 and conveyed to the determination module 202 and the modification module 204. The determination module 202 may interface with the modification module 204 to generate one or both of the additional feature modification 245 and a modified distribution procedure 211. The additional feature modification 245 and the modified distribution procedure 211 may be based on the additional output 243 from the optimization engine 150. For instance, the determination module 202 may generate the modified distribution procedure 211 in response to the additional output 243 indicating that the first distribution procedure 210 (or a previous, modified distribution procedure such as 211) introduced failure into rollout of the product update 218. Additionally or alternatively, the modification module 204 may generate the additional feature modification 245 responsive to the additional output 243 indicating that the reason for the failure after the rollout of the product update 218 included a setting or a parameter of the endpoints 106 or the managed network 110.

The determination module 202 and the modification module 204 may communicate the modified distribution procedure 211 and/or the additional feature modification 245 to the security engine 141 and the managed network 110, respectively. For instance, the determination module 202 and the modification module 204 may communicate the modified distribution procedure 211 and/or the additional feature modification 245 via the communication module 206. Additionally, the additional feature modification 245 may be communicated to one or more of the endpoints 106 directly or via one or more of the management modules of the SAAS management engine 109. The additional feature modification 245 may be substantially similar to the feature modification 213 of FIG. 2C. For instance, the additional feature modification 245 may include instructions, etc., that cause a change of state or conditions at one or more of the endpoints 106.

The security engine 141 may redistribute the product update 218. The security engine 141 may redistribute the product update 218 according to the modified distribution procedure 211. Additionally or alternatively, the security engine 141 may redistribute the product update 218 after the additional feature modification 245 is communicated and implemented in the managed network 110.

In some embodiments, the first distribution procedure 210 may be used during the redistribution operation 209. For instance, the failure may be caused by parameters or settings at the endpoints 106. The additional feature modification 245 may correct the parameters or settings that caused the failure. The security engine 141 may redistribute the product update 218 substantially the same way as it was previously distributed. For example, in some circumstances the additional output 243 may include or include data indicative of a device anomaly. The device anomaly may be the cause directly or indirectly of a failure of the distribution of the product update 218. The device anomaly may be a result of a change to the managed network 110 such as a change to the products 115, a security software implemented in the managed network 110, etc. The additional feature modification 245 may undo or modify the managed network 110 or some component thereof (e.g., a first endpoint of the endpoints 106) to address the device anomaly. After the device anomaly is addressed, the product update 218 may redistribute the product update 218.

Redistribution of the product update 218 may be executed via the modified distribution procedure 211 without implementation of the additional feature modification 245. For instance, the failure may have resulted from the first distribution procedure 210. Accordingly, an adjustment to the distribution procedure may result in a successful update distribution.

Additionally, in some embodiments, the security engine 141 may remove the previously rolled-out product update 218 prior to the redistribution. For instance, the modified distribution procedure 211 may include a removal operation in which a previously distributed product update is removed. After the removal operation, the product update 218 may be redistributed.

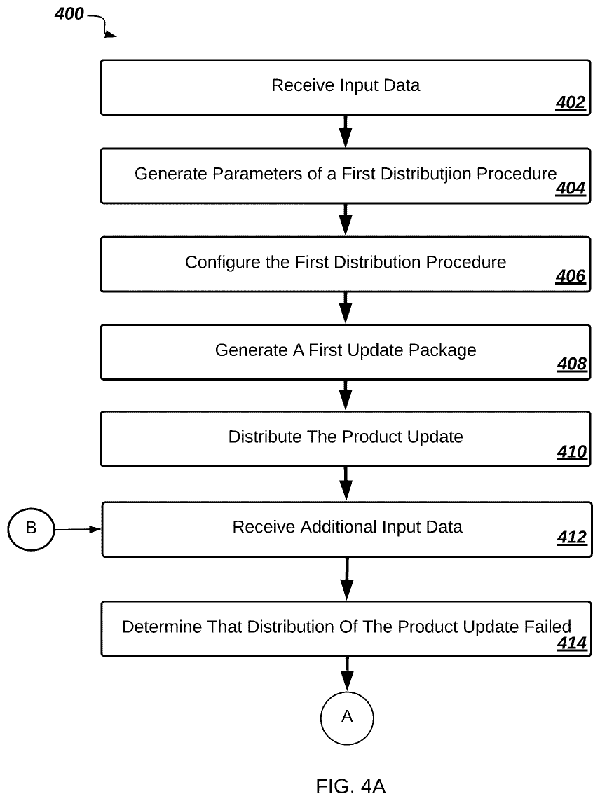

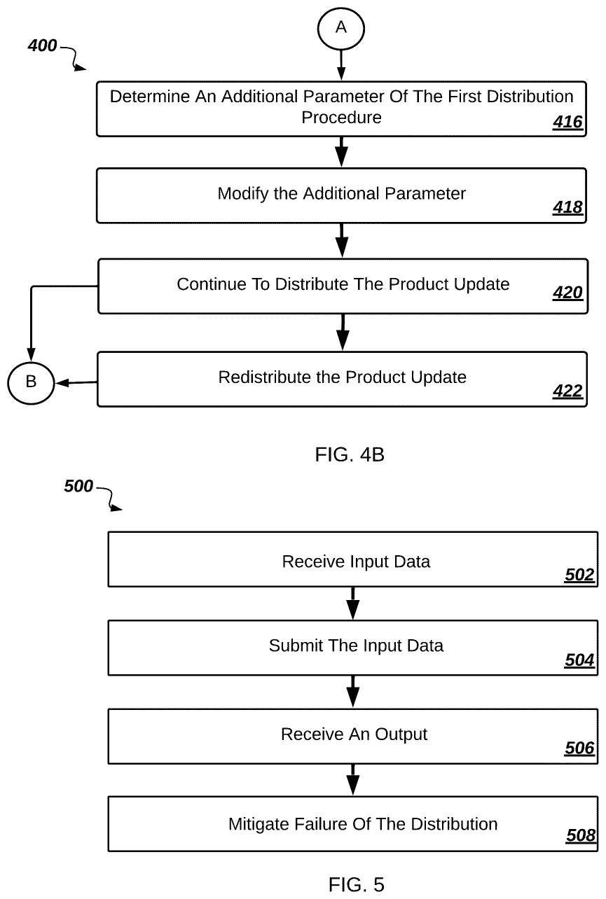

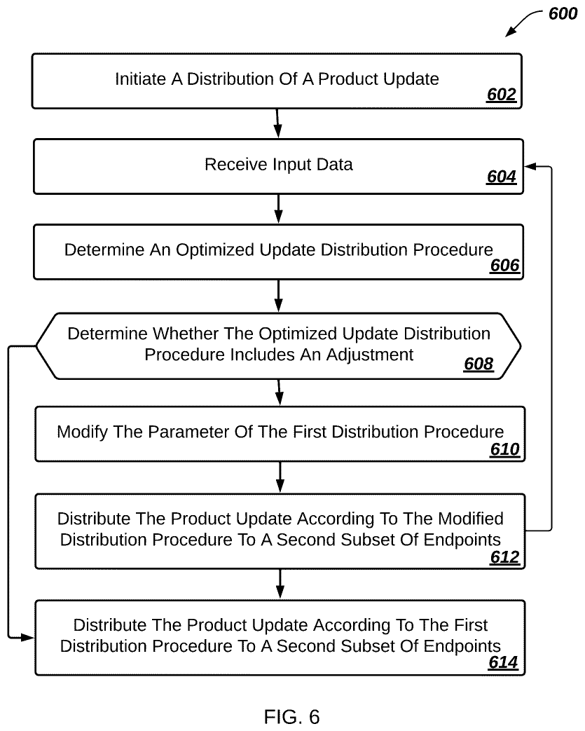

FIG. 3 is a sequence diagram 300 of an example of the process 200 that may be implemented in the operating environment 100 or another suitable environment. The sequence diagram 300 includes the security engine 141, the adjustment module 143, the optimization engine 150, the third-party system 116, and the managed network 110, which includes the first and second rings 222A and 222B. The sequence diagram 300 is separated into three portions 354, 356, and 358. A first portion 354 includes operations 306A, 306B, 306C, 308, 310, 312, 314, or combinations thereof. The first portion 354 is a preemptive portion of the process 200. The first portion 354 is implemented prior to distribution of a product update (operation 316). A second portion 356 includes operations 316, 318, 320, 321, 322, 323, 324, 326, 327, 328, 330, 332, 333, 334, 336, 338, 340, or combinations thereof. The second portion 356 occurs during distribution of the product update to one or more portions of the managed network 110. A third portion 358 includes the remaining operations and occur after distribution the product update to the managed network 110. The first portion 354 corresponds with descriptions of FIGS. 2A, 2B, and methods of FIG. 4. The second portion 356 corresponds with descriptions of FIG. 2C and methods of FIG. 5. The third portion 358 corresponds with descriptions of FIGS. 2D and 2D and methods of FIG. 6.

The sequence diagram 300 is described with reference to a product update that is scheduled for deployment in the managed network 110. An example of the product update might include an update to Adobe™ Acrobat™ patch. The product update (e.g., the actual code changes or instructions) may be generated by a vendor. For instance, the product update may be generated by Adobe. The third-party system 116 may include a server or system of the vendor (e.g., an Adobe helpx site (https://helpx.adobe.com/security/security-bulletin.html) or may include a website or similar source that describes the update but is not hosted or provided directly by the vendor (e.g., https://www.securityweek.com/adobe-patches-critical-code-execution-bugs/, which is hosted by SecurityWeek™ or https://nvd.nist.gov/vuln/detail/CVE-2025-49533, which is hosted by the National Vulnerability Database). Additionally, the sequence diagram 300 describes two rings 222. Similar operations may be implemented in managed networks 110 including a single ring or more than two rings 222.

The first portion 354 of the sequence diagram 300 begins with reception of input data by the optimization engine 150 from the managed network 110 and/or the third-party system 116. In the sequence diagram 300, these are depicted as operations 306A, 306B, 306C. The input data are described elsewhere in the present disclosure and includes data representative of the first and second rings 222A and 222B as well as details of a product update such as historical failure rates of implementation of the product update.

The optimization engine 150 conducts an analysis of the input data (operation 308) related to the product update. The analysis identifies one or more parameters of a successful distribution of the product update. The parameters might include times (e.g., how long a successful distribution takes, which endpoints (e.g., 106) successfully implement the product update, etc.). The optimization engine 150 communicates the parameters to the adjustment module 143 (operation 310).

The adjustment module 143 generates a first distribution procedure (operation 312) that controls the distribution of the product update. The first distribution procedure includes one or more of the parameters that are output by the optimization engine 150. For example, the first distribution procedure might include which endpoints are included in the first ring 222A and the second ring 222B, sizes of the first ring 222A and the second ring 222B, soak times for each of the rings 222, etc. The adjustment module 143 communicates the first distribution procedure to the security engine 141 (operation 314). The security engine 141 distributes the product update to the first ring 222A (operation 316) using the first distribution procedure. Accordingly, the first portion 354 results in the first distribution procedure that has been optimized using the input data. The first distribution procedure is developed based on information of the managed network 110 to avoid failed product update distribution failure. For example, increasing a soak time allocated for the first ring 222A because the product update requires a reboot, may improve implementation of the product update at the endpoints of the first ring 222A.

The second portion 356 occurs at least partially during distribution of the product update to the first ring 222A and the second ring 222B. Accordingly, the second portion 356 begins at operation 318 in which the product updates are distributed to the first ring 222A. Distribution to the first ring 222A may include communication to endpoints of the first ring 222A a patch package (also referred to as a product update package). The patch package may include the product update (e.g., instructions or software code) or instructions and a source where the product update is accessible. The patch package may further include scripting that triggers operations at the endpoints for receiving, installing, and executing the product update such a reboot triggers, application exit instructions, setting modifications, uninstall instruction for previous versions, and the like. The endpoints install and implement the product update at different times. Accordingly, the patch package may be communicated to all of the first ring 222A at one time, but it might take several hours or several days for some of the endpoints to install and implement the product update. During this time, additional input data may be generated.

During the distribution, additional input data is communicated to the optimization engine 150 (operation 320). During the second portion 356, the additional input data is collected from the endpoints of the first ring 222A (and later at the second ring 222B, described below). The additional input data includes the information indicative of whether or not the product update is successfully implemented at the endpoints. For instance, the additional input data may include data indicating that the product update is causing system crashes on the endpoints, data indicating that users of the endpoints are submitting IT tickets related to the product update, data indicating that the product update is being implemented without system or application failures and an implementation time.

The optimization engine 150 receives the additional input data and conducts an additional, ongoing analysis (operation 321) based on the additional input data. The optimization engine 150 determines whether the product update distribution is failing and parameters for a successful update distribution. For instance, the additional input data might indicate that greater than 50% of the endpoints of the first ring 222A results in a system crash. Accordingly, the optimization engine 150 determines that the update distribution is failing. Additionally still, the optimization engine 150 may determine that the update distribution is failing at endpoints having a particular characteristic such as particular OS, particular jurisdiction, particular security setting, and the link. In contrast, the optimization engine 150 might determine that implementation of the product update occurs quickly (less time than provided for in the first distribution procedure). Accordingly, the optimization engine 150 determines that the update distribution is successful and may be accelerated. The optimization engine 150 communicates (operation 322) parameters to the adjustment module 143.

The adjustment module 143 performs an analysis (operation 323) of the output of the optimization engine 150. Responsive to an indication that the optimization engine 150 determined that the product update is successfully deployed, the sequence diagram 300 skips to operation 328. At operation 328 the product update is distributed to the second ring 222B. That is, no changes are made to the first distribution procedure, and it is allowed to continue through the first ring 222A.

Responsive to an indication that the optimization engine 150 determined that the product update deployment is failing, the adjustment module 143 generates a second distribution procedure. The second distribution procedure modifies one or more parameters of the first distribution procedure. For instance, the second distribution procedure might increase a soak time, modify the patch package, change the endpoints of the first ring 222A, modify another parameter or some combination thereof. The adjustment module 143 communicates the second distribution procedure to the security engine 141.

The security engine 141 deploys the product update to the first ring 222A or a remaining portion thereof using the second distribution procedure (operation 326). In some embodiments, the sequence diagram 300 includes operation 327 in which the additional data collection of operation 320 is repeated and operations 321, 322, 323, and 324 are repeated until deployment to the first ring 222A is completed. Through this iterative process, additional distribution procedures may be generated and used to distribute the product update.

After the first ring 222A is complete, the security engine 141 distributes the product update to the second ring 222B (operation 328). Portions of the second ring 222B install and implement the product update (operation 330). As endpoints or portions of the second ring 222B install and implement the product update, the operations described with respect to the first ring 222A are repeated relative to the second ring 222B. For instance, the distribution of the product update to the second ring 222B is initiated (operation 328). Additional input data is communicated to the optimization engine 150 (operation 332), which is analyzed by the operation engine (operation 333). The optimization engine 150 provides output to the adjustment module 143 (operation 334), which determines whether modifications to a distribution procedure and generation of modified distribution procedures as necessary (operation 336). If the modified distribution procedure(s) are generated, the adjustment module 143 communicates the modified distribution procedure(s) to the security engine 141. The security engine 141 uses the modified distribution procedure(s) for distribution to the second ring 222B or remaining portions thereof (operation 340). As described with reference to the first ring 222A, the sequence diagram 300 may repeat operations 332, 333, 334, 336, 338, and 340. If no modified distribution procedures are generated, the security engine 141 continues to distribute the product update according to the distribution procedure used to distribute to the first ring 222A.

The third portion 358 occurs after the product update is distributed to the managed network 110. The third portion 358 is implemented to determine whether the product update can be successfully deployed according to the first and/or second portions 354 and 356, but results in system or application failures at the endpoints. The third portion 358 is a post-deployment sub-process that evaluates whether the product update results in the technical issues.

The third portion 358 begins with reception of additional input data by the optimization engine 150 from the managed network 110. The additional input data may be provided by the endpoints of the rings 222 and/or other components of the managed network 110. For instance, the additional input data may include an increase in IT tickets, inoperable applications or systems, system or application errors, etc. In the sequence diagram 300, the communication of the additional input data is depicted as operations 342A and 342B.

The optimization engine 150 conducts an analysis of the additional input data (operation 344) related to the product update. The analysis determines whether the product update resulted in failures in the managed network 110. For instance, the product update may have been distributed to one hundred endpoints included in the rings 222. The additional input data indicates that twenty-five IT tickets were submitted following the product update distribution identifying a technical issue related to the product update. In this example, the optimization engine 150 may determine that the product update results in a system or application failure.

Additionally, the optimization engine 150 may determine an endpoint configuration that results in the failure. From the example above, the endpoints experiencing the technical issue have a common characteristic such as a common security setting, a common operating system, a common device type, a common jurisdiction/geographic location, etc. That is, the system or application failure may be related to a setting or a state of the endpoints. Accordingly, the optimization 150 may identify the common characteristic of endpoints experiencing the technical issue.

The optimization engine 150 identifies one or more parameters of a successful distribution of the product update and/or endpoint configurations necessary for successful deployment. For instance, the parameters might include tasks or changes implemented at the endpoints that result in successful implementation, times (e.g., how long a successful distribution takes, which endpoints (e.g., 106) successfully implement the product update, etc.). The optimization engine 150 communicates the parameters to the adjustment module 143 (operation 346).

The adjustment module 143 analysis the output from the optimization engine 150 (operation 348). In some instances, the adjustment module 143 may be configured to generate a mitigation action that modifies the endpoint configuration of the endpoints or modifies the patch package. An example of the patch package might include a reboot instruction or update a universal resource locator (URL) address of a functional patch. Additionally or alternatively, the adjustment module 143 may generate an update redistribution procedure. The update redistribution procedure may be substantially equivalent to the first or second distribution procedures, but include parameters generated responsive to the output of the optimization engine 150. The adjustment module 143 communicates the update redistribution procedure to the security engine 141 (operation 350).

The security engine 141 redeploys the product update (operation 352). The redeployment of the product update is performed using the update redistribution procedure. The redeployment of the product update may be followed by one or more of the operations of the second portion 356 and a repetition of the third portion 358, which are discussed above.

FIGS. 4A and 4B are a flow chart of an example method 400 of reducing operational impact resulting from a dysfunctional rollout of a product update in a managed network. The operations of 402, 404, 406, and 408 may occur prior to distribution of a product update related to a software application on endpoints of a managed network. In these and other embodiments, the method 400 implements a preemptive analysis based on the input data (as described below). The method 400 may further include an optional, concurrent analysis that is described in blocks 412, 414, 416, 418, 420, and 422.

Referring to FIG. 4A, the method 400 may begin at block 402, in which input data is received. The input data is related to distribution of the product update directed to endpoints of a managed network. For example, the input data may include data representative of: operating parameters of one or more of the endpoints, device state of one or more of the endpoints, metadata of the product update, application telemetry of products installed on the endpoints, a patch history of one or more of the endpoints, user feedback and sentiment, a content feed received by the security module, rates or numbers of deployment failures, failure in particular endpoints characterized by device type, or products implemented on particular endpoints, other input data or combinations thereof.

At block 404, parameters of a first distribution procedure are generated. The parameters are generated based on the received input data. The parameters are generated based on an optimized update distribution procedure that reduces disruption risks caused by implementation of the product update at the endpoints and maximizes a distribution speed of the product update in the managed network.

In some embodiments, the generating the parameters includes submitting the input data to a security management optimization engine. The security management optimization engine is trained on data representative of operation of the endpoints and is trained to find and learn a model for an optimal balance between the distribution speed of the product update and a disruption risk introduced by the product update to the managed network. The security management optimization engine generates an output, which includes the output includes the parameters and at least a portion of a first update package.

Additionally, in some embodiments, the output includes an endpoint configuration of at least a portion of the endpoints that reduces device anomalies or technical issues following implementation of the product update. In these and other embodiments, a feature of the endpoints may be modified preemptively to conform the endpoints to the endpoint configuration prior to distribution of the product update.

Additionally, in some embodiments, the output of security management optimization engine might include an indication that distribution of the product update according to a preconfigured distribution procedure is likely to fail. In these and other embodiments, the parameters scale back the distribution of the product update to improve likelihood of successful deployment.

At block 406, the first distribution procedure is configured. The first distribution procedure is configured to include at least a portion of the parameters of the optimized update distribution procedure. The portion of the parameters may include a selection parameter indicating a subset of the endpoints to which the endpoints are first (in time) distributed and a time parameter indicating a period of time granted to the subset of the endpoints to locally implement the product update. The first distribution procedure includes a modification of a preconfigured distribution procedure according to which product updates are otherwise distributed in the managed network. The configuring the first distribution procedure includes modifying a preconfigured selection parameter and a preconfigured time parameter of the preconfigured distribution procedure to conform the preconfigured selection parameter and the time parameter to the optimized update distribution procedure.

For example, the first distribution procedure may include a ring deployment operation. In this example of the ring deployment operation, the configuring the first distribution procedure includes one or more or a combination of: modifying a soak time for the product update of a preconfigured distribution procedure, modifying a ring target of a preconfigured distribution procedure, modifying ring target election a preconfigured distribution procedure, modifying number of the endpoints in a ring or a percentage of the managed network in a ring of a preconfigured distribution procedure, modifying a time to successful deployment of a preconfigured distribution procedure, modifying a time to initiate a subsequent ring following successful deployment of an earlier ring of a preconfigured distribution procedure, modifying a ring definition of a preconfigured distribution procedure, another modification, or combinations thereof.

At block 408, a first update package may be generated. The first update package is configured to enable implementation of the product update at the endpoints. Specifically, the first update package may include scripts, links, instructions, etc. that when received by the endpoints, implements (e.g., installs) the product update. As described above, one or more portions of the first update package may be based on the output of the security management optimization engine.

At block 410, the product update is distributed using the first update package according to the first distribution procedure. The product update is distributed such that the product update is received at the endpoints and locally implemented at the endpoints. Local implementation of the product update results in changes at the endpoints such as changes to one or more software applications (e.g., changes to code bases, changes to settings, etc.) or removal an installed software application and replacement of the installed software application with an updated version.

In some embodiments, the product update includes a first product update of multiple product updates outstanding at the endpoints. In these embodiments, the input data is further related to distribution of each product update of the multiple product updates. The optimized update distribution procedure includes a sequence of distribution of each product update of the multiple product updates. Accordingly, the parameters include the sequence of distribution of the multiple product updates and the configuring the first distribution procedure includes implementing the sequence.

At block 412, additional input is received. The additional input data is received during at least a portion of a distribution of the product update according to the first distribution procedure. In some embodiments, the receiving additional input data is a continual data gathering process that occurs during the distribution of the product update according to the first distribution procedure and one or more modified distribution procedure(s). The additional input data may include or be substantially similar to the input data described above.

At block 414, it may be determined that distribution of the product update failed at a portion of the subset of endpoints. The determination is based on the additional input data. The determining that the distribution of the product update failed includes submitting the additional input data to the security management optimization engine and receiving additional output from the security management optimization engine. The additional output includes an adjustment to the additional parameter of the first distribution procedure. The security management optimization engine is as described above and trained on data representative of operation of the endpoints of the managed network and is trained to find and learn a model for an optimal balance between a distribution speed of the product update and a disruption risk introduced by the product update to an enterprise. The security management optimization engine may include one or both of an AI engine and an ML algorithm.

Referring to FIG. 4B, at block 416, an additional parameter of the first distribution procedure is determined. The additional parameter is a parameter of the first distribution procedure that caused the distribution of the product update to fail. The determination of the additional parameter may be implemented responsive to a determination that the product update failed or is failing.

At block 418, the additional parameter of the first distribution procedure may be modified to generate a modified distribution procedure. At block 420, distribute the product update may be continued according to the modified distribution procedure to a remaining portion of the subset of endpoints. At block 422, the product update may be redistributed to the portion of the subset of endpoints.

The method 400 may proceed through one or more operations of blocks 412, 414, 416, 418, 420, and 422. The modified distribution procedure may be updated as the additional input data is received and analyzed. Accordingly, the method 400 tunes the distribution procedures as the product update is distributed.

FIG. 5 is a flowchart of another example method 500 of reducing operational impact resulting from a dysfunctional rollout of a product update in a managed network, according to at least one embodiment of the present disclosure. The method 500 may begin at block 502 in which input data may be received. The input data may be received after distribution of a product update to endpoints of a managed network. The input data may be received from a subset of the multiple endpoints. The input data may include user feedback and sentiment and device state of at least a portion of the endpoints.

At block 504, the input data may be submitted. The input data may be submitted to a security management optimization engine. The security management optimization engine is trained on data representative of operation of the endpoints and is trained to identify a disruption risk introduced by the product update and data indicative of the disruption risk occurring in the managed network. The security management optimization engine may include one or both of an artificial intelligence (AI) engine and a machine learning (ML) algorithm.

At block 506, an output may be received. The output may be received from the security management optimization engine. The output may include an indication that the distribution of the product update failed or is failing at all or a portion of the endpoints. In some embodiments, the output may further include an adjustment to a parameter of an endpoint configuration of at least a portion of the endpoints, a device anomaly resultant from a change to the managed network caused by the product update, an adjustment to a parameter of a distribution procedure according to which the product update was distributed to the plurality of endpoints, or some combination thereof.

At block 508, failure of the distribution of the product update may be mitigated. The failure may be mitigated based on the output. The mitigation includes a change to a system to address a disruption caused by the failure. For instance, mitigating the failure may include modifying the parameter of the distribution procedure according to the adjustment of the output to generate a modified distribution procedure and redistributing the product update according to the modified distribution procedure to the plurality of endpoints.

In some embodiments, the distribution procedure includes a ring deployment operation and distribution of the product update to the endpoints is rollout of the product update into a ring of the ring deployment operation. In these and other embodiments, the mitigating the failure may include modifying the parameter of the distribution procedure according to the adjustment of the output to generate a modified distribution procedure. The modified distribution procedure is then used during rollout of the product update to an additional (or subsequent) ring of the ring deployment operation.

Some examples of the modifying the parameter includes modifying a soak time for the product update, modifying a ring target, modifying ring target election, modifying a number of the endpoints in a ring or a percentage of the managed network in a ring, modifying a time to successful deployment, modifying a time to initiate a subsequent ring following successful deployment of an earlier ring, modifying a ring definition, scaling back deployment of the product update to enable additional input from additional endpoints of the additional ring, other modifications to other parameters, or combinations thereof. Additionally still, the mitigating the failure may include modifying the parameter of a first endpoint of the multiple endpoints and redistributing of the product update.

The method 500 may be implemented with multiple product updates that are rolled out to the endpoints. In these embodiments, the product update may include a first product update of the multiple product updates that have been distributed. For instance, the multiple product updates may have been rolled out in a short period of time such as a day or over a weekend. In these and other embodiments, the input data may be further related to distribution of each product update of the multiple product updates. The security management optimization engine is further trained to identify additional disruption risks introduced by the multiple product updates and to identify data indicative of the additional disruption risks occurring in the managed network. In embodiments in which multiple product updates are analyzed, the output may include a sequence of distribution of the multiple product updates as well as the outputs described above with reference to block 506 for one or more of the multiple product updates. Additionally, mitigating the failure may include redistributing at least a portion of the multiple product updates according to the sequence. The mitigating may also include the mitigating actions described in block 508 relative to one or more of the multiple product updates.

FIG. 6 is a flow chart of example method 600 of reducing operational impact resulting from a dysfunctional rollout of a product update in a managed network, according to at least one embodiment of the present disclosure. The method 600 may begin at block 602 in which a distribution a product update is initiated. The distribution of the product update may be directed to a first subset of endpoints of a managed network according to a first distribution procedure. In some embodiments, the first distribution procedure may be an optimized distribution procedure that may be generated according to the method 400. In other embodiments, the first distribution procedure may be a default distribution procedure or a distribution procedure based on administrator input.

The operations of blocks 604, 606, 608, 610, or some combination thereof of the method 600 may occur during at least a portion of the distribution of the product update to the first subset of endpoints according to the first distribution procedure. For instance, at block 604, input data may be received. The input data is related to the distribution of the product update directed to the first subset. The receipt of the input data includes a continual data gathering process that occurs during the distribution of the product update. The input data may include data representative of one or more or a combination of parameters of one or more of the endpoints, device state of one or more of the endpoints, metadata of the product update, application telemetry of products installed on the endpoints, a patch history of one or more of the endpoints, user feedback and sentiment, a content feed received by the security module, rates or numbers of deployment failures, failure in particular endpoints characterized by device type, or products implemented on particular endpoints, or another input data related to the distribution.

At block 606, an optimized update distribution procedure may be determined. The optimized update distribution procedure is based on the received input data. The optimized update distribution might include changes or modifications to the first distribution procedure. Because the received input data is collected during the product update distribution to the first subset, the received input data might indicate that an aspect or parameter of the first distribution procedure should be adjusted. In some embodiments, the determining the optimized update distribution procedure includes submitting the received input data to a security management optimization engine. The security management optimization engine is trained on data representative of operation of the endpoints of the managed network and is trained to find and learn a model for an optimal balance between a distribution speed of the product update and a disruption risk introduced by the product update to an enterprise. The security management optimization engine includes one or both of an artificial intelligence (AI) engine and a machine learning (ML) algorithm.

At block 608, it may be determined whether the optimized update distribution procedure includes an adjustment. Responsive to the optimized update distribution including an adjustment to a parameter of the first distribution procedure (“YES” at block 608), the method 600 may proceed to block 610. Responsive to the optimized update distribution not including an adjustment to a parameter of the first distribution procedure (“NO” at block 608), the method 600 may proceed to block 614.

At block 610, the parameter of the first distribution procedure is modified. The parameter of the first distribution procedure is modified to generate a modified distribution procedure. In some embodiments, the modifying the parameter of the first distribution procedure is a continual, adaptive process that tunes the modified distribution procedure as the product update is distributed. An example of the modifying the parameter includes scaling back deployment of the product update, which may increase a time of the deployment.

At block 612, the product update may be distributed according to the modified distribution procedure. The product update distribution may be directed to a second subset of endpoints of the managed network. For example, the first distribution procedure may include a ring deployment operation. In these embodiments, the modifying the parameter includes one or more or a combination of: automatically modifying a soak time for the product update, automatically modifying a ring target, automatically modifying ring target election, automatically modifying number of the endpoints in a ring or a percentage of the managed network in a ring, automatically modifying a time to successful deployment, automatically modifying a time to initiate a subsequent ring following successful deployment of an earlier ring, and automatically modifying a ring definition.

At block 614, distribution of the product update according to the first distribution procedure may be continued. For instance, the product update may be distributed according to the first distribution procedure to the second subset of endpoints of the managed network.

The method 600 may include additional operations related to identification and mitigation of device anomalies. For instance, the method 600 may include identifying a device anomaly resultant from a change to at least one endpoint of the first subset that is caused by the distribution of the product update. For instance, the product update might be causing a system or application failure after the product update is implemented. The device anomaly is identified based on the received input data and may be generated by the security management optimization engine. In these and other embodiments, it may be determined whether the device anomaly is avoidable by an alteration to a parameter or a state of an endpoint configuration of one or more endpoints. Responsive to the device anomaly being avoidable, the method 600 may include modifying the parameter or the state of the endpoint configuration of the endpoints before distribution of the product update to the first endpoint. The device anomaly identification and modifications may occur during the remaining operations of the method 600. For instance, the first distribution procedure may be changed or not changed as the device anomaly identification and modification occurs. Accordingly, the product update may be distributed according to the modified distribution procedure to an endpoint that has been modified; the product update may be distributed according to the first distribution procedure (e.g., no modified distribution procedure generated) to an endpoint that has been modified; the product update may be distributed according to the modified distribution procedure to an endpoint that has not been modified (e.g., no device anomaly); and the product update may be distributed according to the first distribution procedure to an endpoint that has not been modified.

In some embodiments, the receiving the input data of block 602 may be a continual data gathering process that occurs during the distribution of the product update. Accordingly, the modifying the parameter of the first distribution procedure and/or the parameters of the first endpoint is a continual, adaptive process that tunes the modified distribution procedure as the product update is distributed. Accordingly, the method 600 may repeat one or more of blocks 604, 606, 608, 610, 612, 614, or some combinations thereof.

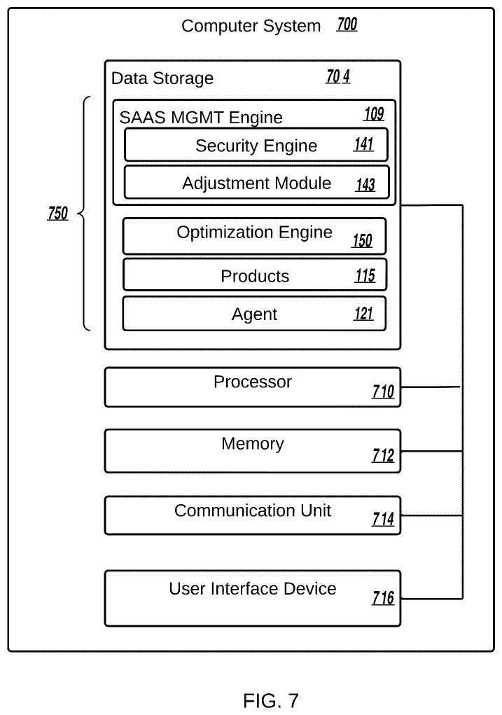

The methods 400, 500, and 600 may be performed by the management device 104 described elsewhere in the present disclosure or by another suitable computing system, such as the computer system 700 of FIG. 7. In some embodiments, the management device 104 or the other computing system may include or may be communicatively coupled to a non-transitory computer-readable medium (e.g., the memory 712 of FIG. 7) having stored thereon programming code or instructions that are executable by one or more processors (such as the processor 710 of FIG. 7) to cause a computing system or the management device 104 to perform or control performance of the methods 400, 500, and 600. Additionally or alternatively, the management device 104 may include the processor 710 that is configured to execute computer instructions to cause the management device 104 or other computing systems to perform or control performance of the methods 400, 500, and 600. The management device 104 or the computer system 700 implementing the methods 400, 500, and 600 may be included in a cloud-based managed network, an on-premises system, or another suitable network computing environment. Although illustrated as discrete blocks, one or more blocks in FIGS. 4A-6 may be divided into additional blocks, combined into fewer blocks, or eliminated, depending on the desired implementation.

FIG. 7 illustrates an example computer system 700 configured for reducing operational impact resulting from a dysfunctional rollout of a product update in a managed network, according to at least one embodiment of the present disclosure. The computer system 700 may be implemented in the operating environment 100 FIG. 1, for instance. Examples of the computer system 700 may include the management device 104, the third-party system 116, one or more of the endpoints 106, or some combination thereof. The computer system 700 may include one or more processors 710, a memory 712, a communication unit 714, a user interface device 716, and a data storage 704 that includes one or more or a combination of the SAAS management engine 109, the security engine 141, the adjustment module 143, the optimization engine 150, the products 115, and the agent 121 (collectively, system modules 750).

The processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 7, the processor 710 may more generally include any number of processors configured to perform individually or collectively any number of operations described in the present disclosure. Additionally, one or more of the processors 710 may be present on one or more different electronic devices or computing systems. In some embodiments, the processor 710 may interpret and/or execute program instructions and/or process data stored in the memory 712, the data storage 704, or the memory 712 and the data storage 704. In some embodiments, the processor 710 may fetch program instructions from the data storage 704 and load the program instructions in the memory 712. After the program instructions are loaded into the memory 712, the processor 710 may execute the program instructions.

The memory 712 and the data storage 704 may include computer-readable storage media for carrying or having computer-executable instructions or data structures stored thereon. Such computer-readable storage media may include any available media that may be accessed by a general-purpose or special-purpose computer, such as the processor 710. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 710 to perform a certain operation or group of operations.

The communication unit 714 may include one or more pieces of hardware configured to receive and send communications. In some embodiments, the communication unit 714 may include one or more of an antenna, a wired port, and modulation/demodulation hardware, among other communication hardware devices. In particular, the communication unit 714 may be configured to receive a communication from outside the computer system 700 and to present the communication to the processor 710 or to send a communication from the processor 710 to another device or network (e.g., the network 120 of FIG. 1).

The user interface device 716 may include one or more pieces of hardware configured to receive input from and/or provide output to a user. In some embodiments, the user interface device 716 may include one or more of a speaker, a microphone, a display, a keyboard, a touch screen, or a holographic projection, among other hardware devices.

The system modules 750 may include program instructions stored in the data storage 704. The processor 710 may be configured to load the system modules 750 into the memory 712 and execute the system modules 750. Alternatively, the processor 710 may execute the system modules 750 line-by-line from the data storage 704 without loading them into the memory 712. When executing the system modules 750, the processor 710 may be configured to perform one or more processes or operations described elsewhere in this disclosure.

Modifications, additions, or omissions may be made to the computer system 700 without departing from the scope of the present disclosure. For example, in some embodiments, the computer system 700 may not include the user interface device 716. In some embodiments, the different components of the computer system 700 may be physically separate and may be communicatively coupled via any suitable mechanism. For example, the data storage 704 may be part of a storage device that is separate from a device, which includes the processor 710, the memory 712, and the communication unit 714, that is communicatively coupled to the storage device. The embodiments described herein may include the use of a special-purpose or general-purpose computer including various computer hardware or software modules, as discussed in greater detail below.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”), the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of reducing operational impact resulting from a dysfunctional rollout of a product update in a managed network, the method comprising:
prior to distribution of a product update related to a software application on endpoints of a managed network:
receiving input data related to distribution of the product update directed to endpoints of the managed network;
generating, based on the received input data, parameters of a first distribution procedure, wherein the parameters are generated based on an optimized update distribution procedure that reduces disruption risks caused by implementation of the product update at the endpoints and maximizes a distribution speed of the product update in the managed network;
configuring the first distribution procedure to include a portion of the parameters of the optimized update distribution procedure, wherein:
the portion of the parameters includes selection parameter indicating a subset of the endpoints to which the endpoints are first distributed and a time parameter indicating a period of time granted to the subset of the endpoints to locally implement the product update;
the first distribution procedure includes a modification of a preconfigured distribution procedure according to which product updates are otherwise distributed in the managed network; and
the configuring the first distribution procedure includes modifying a preconfigured selection parameter and a preconfigured time parameter of the preconfigured distribution procedure to conform the preconfigured selection parameter and the time parameter to the optimized update distribution procedure;
generating a first update package configured to enable implementation of the product update at the endpoints; and
distributing the product update using the first update package according to the first distribution procedure such that the product update is received at the endpoints and locally implemented at the endpoints.

2. The method of claim 1, wherein the generating the parameters includes submitting the input data to a security management optimization engine, wherein the security management optimization engine is trained on data representative of operation of the endpoints and is trained to find and learn a model for an optimal balance between the distribution speed of the product update and a disruption risk introduced by the product update to the managed network.

3. The method of claim 2, wherein:
the security management optimization engine generates an output;
the output includes the parameters; and
the output includes at least a portion of the first update package.

4. The method of claim 3, wherein:
the output includes an endpoint configuration of at least a portion of the endpoints that reduces device anomalies or technical issues following implementation of the product update; and
the method further comprises modifying at least one feature of the endpoints preemptively to conform the endpoints to the endpoint configuration prior to distribution of the product update.

5. The method of claim 3, wherein the output includes:
an indication that distribution of the product update according to a preconfigured distribution procedure is likely to fail; and
the parameters are configured to scale back the distribution of the product update.

6. The method of claim 1, wherein:
the first distribution procedure includes a ring deployment operation; and
the configuring the first distribution procedure includes one or more or a combination of:
modifying a soak time for the product update of a preconfigured distribution procedure;
modifying a ring target of a preconfigured distribution procedure;
modifying ring target election a preconfigured distribution procedure;
modifying number of the endpoints in a ring or a percentage of the managed network in a ring of a preconfigured distribution procedure;
modifying a time to successful deployment of a preconfigured distribution procedure;
modifying a time to initiate a subsequent ring following successful deployment of an earlier ring of a preconfigured distribution procedure; and
modifying a ring definition of a preconfigured distribution procedure.

7. The method of claim 1, wherein the input data includes data representative of one or more or a combination of:
parameters of one or more of the endpoints;
historical deployment failure data;
device state of one or more of the endpoints;
metadata of the product update;
application telemetry of products installed on the endpoints;
a patch history of one or more of the endpoints;
user feedback and sentiment;
a content feed received by a security module;
error log information;
rates or numbers of deployment failures; and
failure in particular endpoints characterized by device type, or products implemented on particular endpoints.

8. The method of claim 1, wherein:
the product update includes a first product update of a plurality of product updates outstanding at the endpoints;
the input data is further related to distribution of each product update of the plurality of product updates;
the optimized update distribution procedure includes a sequence of distribution of each product update of the plurality of product updates;
the parameters include the sequence of distribution of the plurality of product updates; and
the configuring the first distribution procedure includes implementing the sequence.

9. The method of claim 1, further comprising:
receiving additional input data during at least a portion of a distribution of the product update according to the first distribution procedure, the receiving additional input data is a continual data gathering process that occurs during the distribution of the product update according to the first distribution procedure;
determining, based on the additional input data, that distribution of the product update failed at a portion of the subset of endpoints; and
responsive to a determination that the product update failed or is failing:
determining an additional parameter of the first distribution procedure that caused the distribution of the product update to fail;
modifying the additional parameter of the first distribution procedure to generate a modified distribution procedure;
continuing to distribute the product update according to the modified distribution procedure to a remaining portion of the subset of endpoints; and
redistributing the product update to the portion of the subset of endpoints.

10. The method of claim 9, wherein:
the determining that the distribution of the product update failed includes:
submitting the additional input data to a security management optimization engine, wherein the security management optimization engine that is trained on data representative of operation of the endpoints of the managed network and is trained to find and learn a model for an optimal balance between a distribution speed of the product update and a disruption risk introduced by the product update to an enterprise, and the security management optimization engine includes one or both of an artificial intelligence (AI) engine and a machine learning (ML) algorithm;
receiving additional output from the security management optimization engine, wherein the additional output includes an adjustment to the additional parameter of the first distribution procedure; and
the additional input data includes:
operating parameters of one or more of the endpoints;
device state of one or more of the endpoints;
metadata of the product update;
application telemetry of products installed on the endpoints;
a patch history of one or more of the endpoints;
user feedback and sentiment;
a content feed received by a security module;
rates or numbers of deployment failures; and
failure in particular endpoints characterized by device type, or products implemented on particular endpoints.

11. A non-transitory computer-readable medium having encoded therein programming code executable by one or more processors to perform or control performance of operations of reducing operational impact resulting from a dysfunctional rollout of a product update in a managed network, the operations comprising:
prior to distribution of a product update related to a software application on endpoints of a managed network:
receiving input data related to distribution of the product update directed to endpoints of the managed network;
generating, based on the received input data, parameters of a first distribution procedure, wherein the parameters are generated based on an optimized update distribution procedure that reduces disruption risks caused by implementation of the product update at the endpoints and maximizes a distribution speed of the product update in the managed network;
configuring the first distribution procedure to include a portion of the parameters of the optimized update distribution procedure, wherein:
the portion of the parameters includes selection parameter indicating a subset of the endpoints to which the endpoints are first distributed and a time parameter indicating a period of time granted to the subset of the endpoints to locally implement the product update;
the first distribution procedure includes a modification of a preconfigured distribution procedure according to which product updates are otherwise distributed in the managed network; and
the configuring the first distribution procedure includes modifying a preconfigured selection parameter and a preconfigured time parameter of the preconfigured distribution procedure to conform the preconfigured selection parameter and the time parameter to the optimized update distribution procedure;
generating a first update package configured to enable implementation of the product update at the endpoints; and
distributing the product update using the first update package according to the first distribution procedure such that the product update is received at the endpoints and locally implemented at the endpoints.

12. The non-transitory computer-readable medium of claim 11, wherein the generating the parameters includes submitting the input data to a security management optimization engine, wherein the security management optimization engine is trained on data representative of operation of the endpoints and is trained to find and learn a model for an optimal balance between the distribution speed of the product update and a disruption risk introduced by the product update to the managed network.

13. The non-transitory computer-readable medium of claim 12, wherein:
the security management optimization engine generates an output;
the output includes the parameters; and
the output includes at least a portion of the first update package.

14. The non-transitory computer-readable medium of claim 13, wherein:
the output includes an endpoint configuration of at least a portion of the endpoints that reduces device anomalies or technical issues following implementation of the product update; and
the operations further comprise modifying at least one feature of the endpoints preemptively to conform the endpoints to the endpoint configuration prior to distribution of the product update.

15. The non-transitory computer-readable medium of claim 13, wherein the output includes:
an indication that distribution of the product update according to a preconfigured distribution procedure is likely to fail; and
the parameters are configured to scale back the distribution of the product update.

16. The non-transitory computer-readable medium of claim 11, wherein:
the first distribution procedure includes a ring deployment operation; and
the configuring the first distribution procedure includes one or more or a combination of:
modifying a soak time for the product update of a preconfigured distribution procedure;
modifying a ring target of a preconfigured distribution procedure;
modifying ring target election a preconfigured distribution procedure;
modifying number of the endpoints in a ring or a percentage of the managed network in a ring of a preconfigured distribution procedure;
modifying a time to successful deployment of a preconfigured distribution procedure;
modifying a time to initiate a subsequent ring following successful deployment of an earlier ring of a preconfigured distribution procedure; and
modifying a ring definition of a preconfigured distribution procedure.

17. The non-transitory computer-readable medium of claim 11, wherein the input data includes data representative of one or more or a combination of:
parameters of one or more of the endpoints;
historical deployment failure data;
device state of one or more of the endpoints;
metadata of the product update;
application telemetry of products installed on the endpoints;
a patch history of one or more of the endpoints;
user feedback and sentiment;
a content feed received by a security module;
error log information;
rates or numbers of deployment failures; and
failure in particular endpoints characterized by device type, or products implemented on particular endpoints.

18. The non-transitory computer-readable medium of claim 11, wherein:
the product update includes a first product update of a plurality of product updates outstanding at the endpoints;
the input data is further related to distribution of each product update of the plurality of product updates;
the optimized update distribution procedure includes a sequence of distribution of each product update of the plurality of product updates;
the parameters include the sequence of distribution of the plurality of product updates; and
the configuring the first distribution procedure includes implementing the sequence.

19. The non-transitory computer-readable medium of claim 11, wherein the operations further comprise:
receiving additional input data during at least a portion of a distribution of the product update according to the first distribution procedure, the receiving additional input data is a continual data gathering process that occurs during the distribution of the product update according to the first distribution procedure;
determining, based on the additional input data, that distribution of the product update failed at a portion of the subset of endpoints; and
responsive to a determination that the product update failed or is failing:
determining an additional parameter of the first distribution procedure that caused the distribution of the product update to fail;
modifying the additional parameter of the first distribution procedure to generate a modified distribution procedure;
continuing to distribute the product update according to the modified distribution procedure to a remaining portion of the subset of endpoints; and
redistributing the product update to the portion of the subset of endpoints.

20. The non-transitory computer-readable medium of claim 19, wherein:
the determining that the distribution of the product update failed includes:
submitting the additional input data to a security management optimization engine, wherein the security management optimization engine that is trained on data representative of operation of the endpoints of the managed network and is trained to find and learn a model for an optimal balance between a distribution speed of the product update and a disruption risk introduced by the product update to an enterprise, and the security management optimization engine includes one or both of an artificial intelligence (AI) engine and a machine learning (ML) algorithm;
receiving additional output from the security management optimization engine, wherein the additional output includes an adjustment to the additional parameter of the first distribution procedure; and
the additional input data includes:
operating parameters of one or more of the endpoints;
device state of one or more of the endpoints;
metadata of the product update;
application telemetry of products installed on the endpoints;
a patch history of one or more of the endpoints;
user feedback and sentiment;
a content feed received by a security module;
rates or numbers of deployment failures; and
failure in particular endpoints characterized by device type, or products implemented on particular endpoints.
